(19) United States
(12) Patent Application Publication
(10) Pub. No.: US 2021/0243485 A1
(43) Pub. Date: Aug. 5, 2021

(54) RECEIVING APPARATUS, TRANSMISSION APPARATUS, RECEIVING METHOD, TRANSMISSION METHOD, AND PROGRAM

(71) Applicant: SONY CORPORATION, TOKYO (JP)

(72) Inventors: YOSHIYUKI KOBAYASHI, TOKYO (JP); MITSURU KATSUMATA, TOKYO (JP); TOSHIYA HAMADA, TOKYO (JP)

(21) Appl. No.: 17/049,697

(22) PCT Filed: Feb. 27, 2019
(86) PCT No.: PCT/JP2019/007451

§ 371 Date: Oct. 22, 2020

(30) Foreign Application Priority Data
May 8, 2018 (JP) 2018-089795

(51) Int. Cl. H04N 21/234; H04N 21/84; H04N 21/845; H04N 21/233; H04N 21/2343

(52) U.S. Cl. CPC H04N 21/23412; H04N 21/84; H04N 21/234318; H04N 21/233; H04N 21/8456

(57) ABSTRACT

To enable a plurality of pieces of stream data to be switched more flexibly. There is provided a receiving apparatus including a receiving unit that receives second stream data that are object data corresponding to first stream data that are bit stream data.

### TECHNICAL FIELD

The present disclosure relates to a receiving apparatus, a transmission apparatus, a receiving method, a transmission method, and a program.

### BACKGROUND ART

In recent years, over-the-top video (OTT-V) has been the mainstream of streaming services on the Internet. Moving Picture Experts Group phase-Dynamic Adaptive Streaming over HTTP (MPEG-DASH) is beginning to be widely used as the basic technology thereof (see, for example, Non-Patent Document 1).

In content distribution to be performed by use of MPEG-DASH or the like, a server apparatus distributes video stream data and audio stream data in units of segments, and a client apparatus selects a desired segment to play video content and audio content. The client apparatus can switch between video stream data discontinuous in terms of video expression (for example, video stream data different in resolution, bit rate, or the like) by distributing stream data by use of MPEG-DASH or the like. Furthermore, the client apparatus can also switch between audio stream data having no correlation as audio (for example, audio stream data different in language (Japanese, English, or the like) or bit rate).

### CITATION LIST

### Non-Patent Document

Non-Patent Document 1: MPEG-DASH (Dynamic Adaptive Streaming over HTTP) (URL: http://standards.iso.org/ittf/PubliclyAvailableStandards/index.html)
Non-Patent Document 2: INTERNATIONAL STANDARD ISO/IEC 23008-3 First edition 2015-10-15 Information technology High efficiency coding and media delivery in heterogeneous environments Part 3: 3D audio
Non-Patent Document 3: Virtual Sound Source Positioning Using Vector Base Amplitude Panning, AES Volume 45 Issue 6 pp. 456-466, June 1997

### SUMMARY OF THE INVENTION

### Problems to be Solved by the Invention

However, it has been difficult to switch between video stream data and switch between audio stream data at the same timing. More specifically, video stream data and audio stream data are not aligned with each other (in other words, video stream data and audio stream data are separately existing stream data), and are basically different also in segment length. Therefore, it has been difficult to switch between video stream data and switch between audio stream data at the same timing. As a result of switching between video stream data and switching between audio stream data at different timings, there is a problem in that viewer's/listener's interest and realistic feeling are impaired.

Therefore, the present disclosure has been made in view of the above, and provides a new and improved receiving apparatus, transmission apparatus, receiving method, transmission method, and program capable of more flexibly achieving the switching of a plurality of pieces of stream data.

### Solutions to Problems

According to the present disclosure, there is provided a receiving apparatus including a receiving unit that receives second stream data that are object data corresponding to first stream data that are bit stream data.

Furthermore, according to the present disclosure, there is provided a receiving method to be performed by a computer, including: receiving second stream data that are object data corresponding to first stream data that are bit stream data.

Moreover, according to the present disclosure, there is provided a program for causing a computer to receive second stream data that are object data corresponding to first stream data that are bit stream data.

In addition, according to the present disclosure, there is provided a transmission apparatus including a transmission unit that transmits, to an external device, second stream data that are object data corresponding to first stream data that are bit stream data.

Furthermore, according to the present disclosure, there is provided a transmission method to be performed by a computer, including: transmitting, to an external device, second stream data that are object data corresponding to first stream data that are bit stream data.

In addition, according to the present disclosure, there is provided a program for causing a computer to transmit, to an external device, second stream data that are object data corresponding to first stream data that are bit stream data.

### Effects of the Invention

According to the present disclosure, it is possible to more flexibly achieve the switching of a plurality of pieces of stream data as described above.

Note that the above-described effect is not necessarily restrictive, and any of the effects set forth in the present specification or another effect that can be derived from the present specification may be achieved together with or instead of the above-described effect.

### BRIEF DESCRIPTION OF DRAWINGS

FIG. 1 is a diagram for describing a problem to be solved by the present disclosure.

FIG. 2 is a diagram for describing the problem to be solved by the present disclosure.

FIG. 3 is a diagram for describing the problem to be solved by the present disclosure.

FIG. 4 is a diagram for describing the problem to be solved by the present disclosure.

FIG. 5 is a diagram showing a configuration example of an object-based audio bit stream.

FIG. 6 is a diagram showing a configuration example of the object-based audio bit stream.

FIG. 7 is a diagram showing a configuration example of an object_metadatum( ) block.

FIG. 8 is a diagram showing the configuration example of the object_metadatum( ) block.

FIG. 9 is a diagram for describing position information indicated by the object_metadatum( ) block.

FIG. 10 is a diagram for describing position information (difference value and direct value) indicated by the object_metadatum( ) block.

FIG. 11 is a diagram showing a configuration example of an audio_frame( ) block.

FIG. 12 is a diagram for describing an example of MPEG-DASH distribution using object-based audio.

FIG. 13 is a diagram showing a configuration example of an MP4 container in the case of storing an initialization segment and a media segment in the same MP4 container.

FIG. 14 is a diagram showing a configuration example of each MP4 container in the case of storing an initialization segment and a media segment in different MP4 containers.

FIG. 15 is a diagram showing a configuration of a Movie Box (moov).

FIG. 16 is a diagram showing a configuration example of an object_based_audio_SampleEntry, and showing that the object_based_audio_SampleEntry is stored in a Sample Description Box (stsd).

FIG. 17 is a diagram showing a configuration of a Movie Fragment Box (moof) and a Media Data Box (mdat).

FIG. 18 is a diagram showing a configuration of the Media Data Box (mdat).

FIG. 19 is a diagram showing that a client apparatus 200 performs processing for reproducing an object_based_audio_sample on the basis of random access information stored in a Track Fragment Run Box (trun).

FIG. 20 is a diagram showing a schematic configuration of an object_based_audio_SampleEntry in an audio representation transmission pattern (case 1).

FIG. 21 is a diagram showing a schematic configuration of an object_based_audio_sample in the audio representation transmission pattern (case 1).

FIG. 22 is a diagram showing a specific example of an MPD file in the audio representation transmission pattern (case 1).

FIG. 23 is a diagram showing a configuration example of the object_based_audio_SampleEntry in the audio representation transmission pattern (case 1).

FIG. 24 is a diagram showing a configuration example of the object_based_audio_sample in the audio representation transmission pattern (case 1).

FIG. 25 is a diagram showing a schematic configuration of an object_based_audio_SampleEntry in an audio representation transmission pattern (case 2).

FIG. 26 is a diagram showing a schematic configuration of an object_based_audio_sample in the audio representation transmission pattern (case 2).

FIG. 27 is a diagram showing a schematic configuration of an object_based_audio_SampleEntry in the audio representation transmission pattern (case 2).

FIG. 28 is a diagram showing a schematic configuration of an object_based_audio_sample in the audio representation transmission pattern (case 2).

FIG. 29 is a diagram showing a specific example of an MPD file in the audio representation transmission pattern (case 2).

FIG. 30 is a diagram showing a configuration example of the object_based_audio_SampleEntry in the audio representation transmission pattern (case 2).

FIG. 31 is a diagram showing a configuration example of the object_based_audio_sample in the audio representation transmission pattern (case 2).

FIG. 32 is a diagram showing a configuration example of the object_based_audio_SampleEntry in the audio representation transmission pattern (case 2).

FIG. 33 is a diagram showing a configuration example of the object_based_audio_sample in the audio representation transmission pattern (case 2).

FIG. 34 is a diagram showing a specific example of an MPD file in the audio representation transmission pattern (case 2).

FIG. 35 is a diagram showing a configuration example of an object_based_audio_SampleEntry in the audio representation transmission pattern (case 2).

FIG. 36 is a diagram showing a configuration example of an object_based_audio_sample in the audio representation transmission pattern (case 2).

FIG. 37 is a diagram showing a configuration example of an object_based_audio_SampleEntry in the audio representation transmission pattern (case 2).

FIG. 38 is a diagram showing a configuration example of an object_based_audio_sample in the audio representation transmission pattern (case 2).

FIG. 39 is a diagram showing a configuration example of an object_based_audio_SampleEntry in the audio representation transmission pattern (case 2).

FIG. 40 is a diagram showing a configuration example of an object_based_audio_sample in the audio representation transmission pattern (case 2).

FIG. 41 is a diagram showing a schematic configuration of an object_based_audio_SampleEntry in an audio representation transmission pattern (case 3).

FIG. 42 is a diagram showing a schematic configuration of an object_based_audio_sample in the audio representation transmission pattern (case 3).

FIG. 43 is a diagram showing a schematic configuration of an object_based_audio_SampleEntry in the audio representation transmission pattern (case 3).

FIG. 44 is a diagram showing a schematic configuration of an object_based_audio_sample in the audio representation transmission pattern (case 3).

FIG. 45 is a diagram showing a specific example of an MPD file in the audio representation transmission pattern (case 3).

FIG. 46 is a diagram showing a configuration example of an object_based_audio_SampleEntry in the audio representation transmission pattern (case 3).

FIG. 47 is a diagram showing a configuration example of an object_based_audio_sample in the audio representation transmission pattern (case 3).

FIG. 48 is a diagram showing a configuration example of an object_based_audio_SampleEntry in the audio representation transmission pattern (case 3).

FIG. 49 is a diagram showing a configuration example of an object_based_audio_sample in the audio representation transmission pattern (case 3).

FIG. 50 is a diagram showing a configuration example of an object_based_audio_SampleEntry in the audio representation transmission pattern (case 3).

FIG. 51 is a diagram showing a configuration example of an object_based_audio_sample in the audio representation transmission pattern (case 3).

FIG. 52 is a diagram showing a configuration example of an object_based_audio_SampleEntry in the audio representation transmission pattern (case 3).

FIG. 53 is a diagram showing a configuration example of an object_based_audio_sample in the audio representation transmission pattern (case 3).

FIG. 54 is a diagram for describing the switching of metadata.

FIG. 55 is a diagram showing a specific example of an MPD file in the case of describing representation elements in the SegmentList format.

FIG. 56 is a diagram showing a specific example of an MPD file in the case of describing representation elements in the SegmentTemplate format.

FIG. 57 is a diagram showing a specific example of an MPD file in the case of describing representation elements in the SegmentBase format.

FIG. 58 is a diagram showing a specific example of a Segment Index Box.

FIG. 59 is a diagram for describing restrictions on metadata compression.

FIG. 60 is a block diagram showing a configuration example of an information processing system according to an embodiment of the present disclosure.

FIG. 61 is a block diagram showing a functional configuration example of a server apparatus 100.

FIG. 62 is a block diagram showing a functional configuration example of the client apparatus 200.

FIG. 63 is a flowchart showing a specific example of a processing flow of reproducing audio stream data in a case where switching does not occur.

FIG. 64 is a flowchart showing a specific example of a processing flow of acquiring an audio segment in the case where switching does not occur.

FIG. 65 is a flowchart showing a specific example of a processing flow of reproducing an audio segment in the case where switching does not occur.

FIG. 66 is a flowchart showing a specific example of a processing flow of acquiring an audio segment in a case where switching occurs.

FIG. 67 is a flowchart showing the specific example of the processing flow of acquiring an audio segment in the case where switching occurs.

FIG. 68 is a flowchart showing a specific example of a processing flow of reproducing an audio segment in the case where switching occurs.

FIG. 69 is a flowchart showing the specific example of the processing flow of reproducing an audio segment in the case where switching occurs.

FIG. 70 is a flowchart showing a specific example of a processing flow of selecting metadata in the case where switching occurs.

FIG. 71 is a block diagram showing a hardware configuration example of an information processing apparatus 900 that embodies the server apparatus 100 or the client apparatus 200.

### MODE FOR CARRYING OUT THE INVENTION

A preferred embodiment of the present disclosure will be described in detail below with reference to the accompanying drawings. Note that in the present specification and the drawings, the same reference numerals are assigned to constituent elements having substantially the same functional configurations, and redundant description will be thus omitted.

Note that description will be provided in the following order.

1. Outline of Present Disclosure

2. Details of Present Disclosure

3. Embodiment of Present Disclosure

4. Conclusion

### 1. OUTLINE OF PRESENT DISCLOSURE

First, the outline of the present disclosure will be described.

As described above, a client apparatus can switch between video stream data discontinuous in terms of video expression (for example, video stream data different in resolution, bit rate, or the like) by distributing stream data by use of MPEG-DASH or the like. Furthermore, the client apparatus can also switch between audio stream data having no correlation as audio (for example, audio stream data different in language (Japanese, English, or the like) or bit rate).

However, it has been difficult to switch between video stream data and switch between audio stream data at the same timing. More specifically, video stream data and audio stream data are not aligned with each other, and are basically different also in segment length. Therefore, it has been difficult to switch between video stream data and switch between audio stream data at the same timing. As a result of switching between video stream data and switching between audio stream data at different timings, there is a problem in that viewer's/listener's interest and realistic feeling are impaired.

Methods such as “acquisition of duplicate segments” and “pre-roll data transmission” have been proposed as methods for solving this problem.

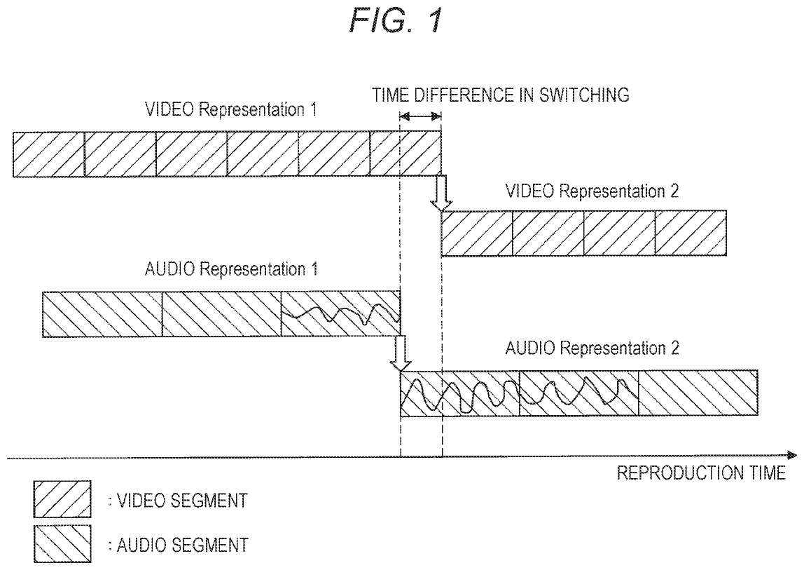

Describing “acquisition of duplicate segments”, for example, there is a time difference in the switching of segments in a case where the timing of switching of audio segments is earlier than the timing of switching of video segments as shown in FIG. 1 (in FIG. 1, the timing of switching from audio representation 1 to audio representation 2 is earlier than the timing of switching from video representation 1 to video representation 2).

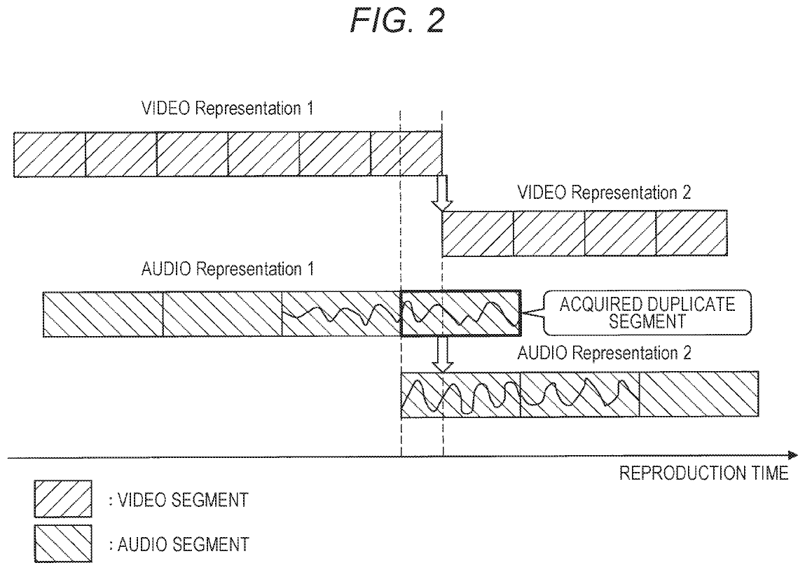

In this case, when switching video segments, the client apparatus acquires not only an audio segment of audio representation provided after the switching (audio representation 2), but also an audio segment of audio representation provided before the switching (audio representation 1) as a duplicate segment, as shown in FIG. 2. As a result, the client apparatus can perform reproduction processing by using the audio segment provided before the switching until the timing of switching the video segments, and perform reproduction processing by using the audio segment provided after the switching after the timing of switching the video segments. Thus, it is possible to eliminate (or reduce) the time difference in the switching of segments. Note that at the time of switching, techniques such as dissolve for video and crossfade for audio have been used together to reduce a user's sense of discomfort.

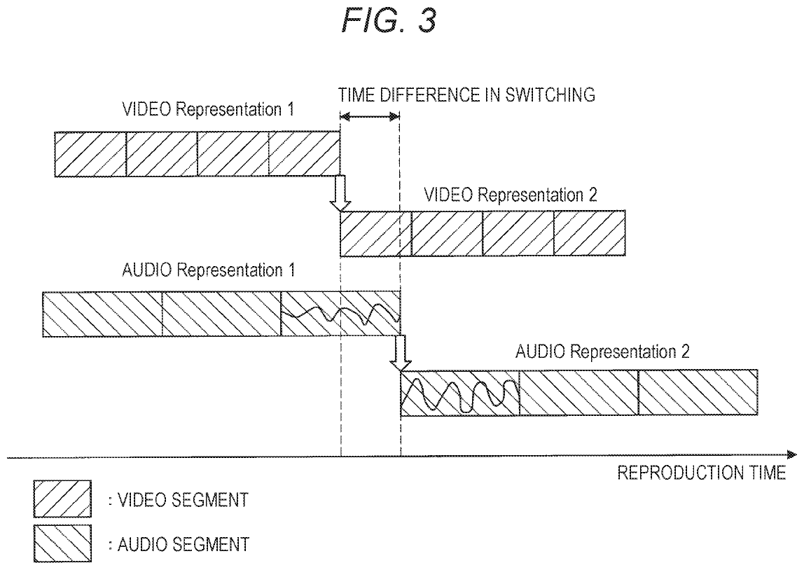

Describing “pre-roll data transmission”, for example, there is a time difference in the switching of segments in a case where the timing of switching of video segments is earlier than the timing of switching of audio segments as shown in FIG. 3 (in FIG. 3, the timing of switching from video representation 1 to video representation 2 is earlier than the timing of switching from audio representation 1 to audio representation 2).

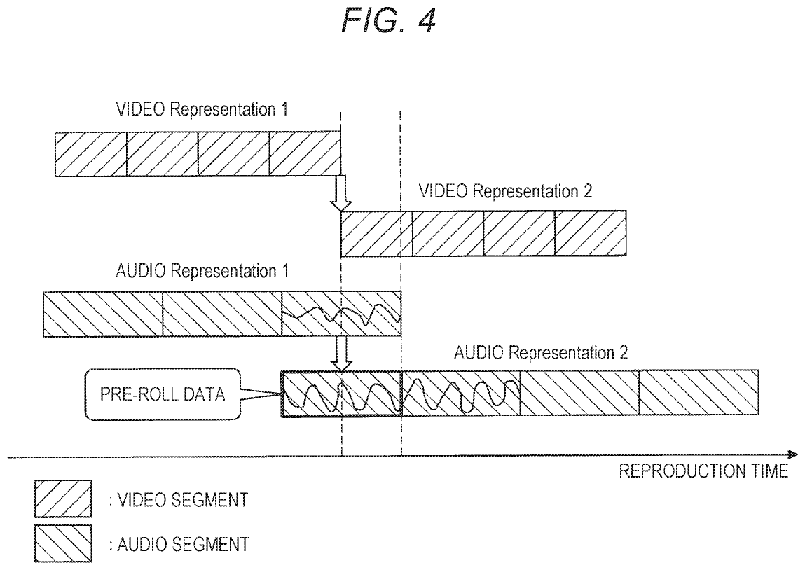

MPEG-H 3d Audio (ISO/IEC 23008-3) defines a method of adding pre-roll data to each audio segment in this case, as shown in FIG. 4. As a result, the client apparatus can perform reproduction processing by using an audio segment provided after the switching, after the timing of switching the video segments. Thus, it is possible to eliminate (or reduce) the time difference in the switching of segments. As in the above-described case, techniques such as dissolve for video and crossfade for audio are used together.

However, with regard to “acquisition of duplicate segments”, it takes extra time to acquire (download or the like) duplicate data. Therefore, there are cases where, for example, switching is performed later than a desired timing (for example, a case where acquisition of duplicate data has not been completed before the timing at which switching is performed). Furthermore, data that are not used for reproduction are acquired (downloaded or the like) both in “acquisition of duplicate segments” and “pre-roll data transmission”. Thus, there is a band wastefully used for the acquisition. In particular, it can be said that “pre-roll data transmission” is more wasteful because pre-roll data are basically added to all segments.

The disclosers of the present case have created the present disclosure in view of the above circumstances. A server apparatus 100 (transmission apparatus) according to the present disclosure generates second stream data that are object data corresponding to first stream data that are bit stream data, and transmits the second stream data to a client apparatus 200 (receiving apparatus). Moreover, the server apparatus 100 includes information regarding the timing of switching the first stream data (hereinafter, referred to as “timing information”) in a media presentation description (MPD) file or the like to be used for reproducing the second stream data.

As a result, when receiving the second stream data and performing the processing for reproducing the second stream data on the basis of metadata corresponding to the data, the client apparatus 200 can switch the second stream data (strictly speaking, the metadata to be used for reproducing the second stream data) at the timing at which the first stream data are switched, on the basis of the timing information included in the MPD file or the like.

Here, the first stream data and the second stream data described above may each be video stream data or audio stream data. More specifically, there may be a case where the first stream data are video stream data and the second stream data are audio stream data, or a case where the first stream data are audio stream data and the second stream data are video stream data. Furthermore, there may be a case where the first stream data are video stream data and the second stream data are video stream data different from the first stream data. In addition, there may be a case where the first stream data are audio stream data and the second stream data are audio stream data different from the first stream data. Hereinafter, a case where the first stream data are video stream data and the second stream data are audio stream data will be described as an example (in other words, the audio stream data are object-based audio data).

### 2. DETAILS OF PRESENT DISCLOSURE

The outline of the present disclosure has been described above. Next, in describing details of the present disclosure, MPEG-DASH and object-based audio will be described first.

The outline of MPEG-DASH (see Non-Patent Document 1 above) is given below. MPEG-DASH is a technique developed for streaming video data and audio data via the Internet. In the distribution to be performed with MPEG-DASH, the client apparatus 200 plays a piece of content by selecting and acquiring the piece of content from among pieces of content with different bit rates according to a change in a transmission band, and the like. Therefore, for example, the server apparatus 100 prepares a plurality of pieces of audio stream data of the same content in different languages, and the client apparatus 200 can change the language of the content by switching audio stream data to be downloaded according to a user operation input or the like.

The outline of object-based audio is given below. For example, as a result of using the MPEG-H 3D Audio (ISO/IEC 23008-3) described in Non-Patent Document 2 above, it is possible to perform reproduction by using a conventional two-channel sound system or a multichannel sound system such as a 5.1-channel. In addition, it is also possible to treat a moving sound source or the like as an independent audio object and encode position information on the audio object as metadata together with audio data of the audio object. Thus, it is possible to easily perform various types of processing during reproduction (for example, adjusting sound volume and adding effects).

In addition, Non-Patent Document 3 above describes a rendering method for audio objects. For example, a rendering method called vector base amplitude panning (VBAP) may be used to set the output of a speaker existing in a replay environment. VBAP is a technique for localizing a sound to the spatial position of each audio object by adjusting the output of three or more speakers that are closest to the spatial position of each audio object. VBAP can also change the spatial position of each audio object (that is, move each audio object).

In addition, the object-based audio has an advantage in that an audio frame can be time-divided into a plurality of divisions and data compression processing (such as differential transmission) can be performed to improve transmission efficiency.

Here, definitions of terms to be used herein are described below. Terms to be used in ISO/IEC 23008-3 (MPEG-H 3D Audio) conform to ISO/IEC 14496-3 (MPEG-4 Audio). Therefore, a comparison with MPEG-4 Audio is also given.

First, the term “audio object” refers to a material sound that is a constituent element for generating a sound field. For example, in a case where content to be played is related to music, the audio object refers to the sound of a musical instrument (for example, guitar, drum, or the like) or the singing voice of a singer. Note that details of a material sound to be used as an audio object are not particularly limited, and will be determined by a content creator. The audio object is referred to as “object”, “the component objects”, or the like in MPEG-4 Audio.

The term “object-based audio” refers to digital audio data generated as a result of encoding position information on an audio object as metadata together with the audio object. A reproduction device that reproduces object-based audio does not output the result of decoding each audio object as it is to speakers, but dynamically calculates the output of each speaker according to the number and positions of the speakers. The audio coding system defined by MPEG-4 Audio is described, in the standard, as “MPEG-4 Audio is an object-based coding standard with multiple tools”.

“Multichannel audio (channel-based audio)” is a general term for a two-channel sound system and multichannel sound systems such as a 5.1-channel. A fixed audio signal is assigned to each channel. A reproduction device outputs the audio signal assigned to each channel to a predetermined speaker (for example, outputs an audio signal assigned to a channel 1 to the left speaker, and outputs an audio signal assigned to a channel 2 to the right speaker). Furthermore, it can also be said that these audio signals are digital sounds to be obtained by the content creator mixing down the above-described audio object before distribution. Note that MPEG-4 Audio allows both multichannel audio data and audio object data to be stored in a single bit stream.

(2.1. Object-Based Audio Bit Stream)

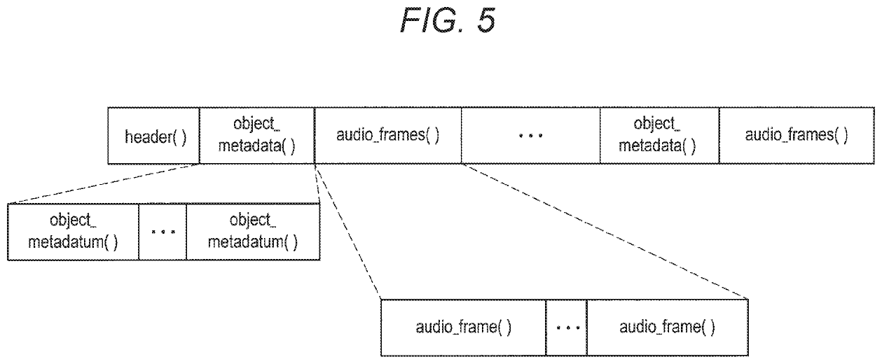

Next, a configuration example of an object-based audio bit stream will be described with reference to FIG. 5. As shown in FIG. 5, an object-based audio bit stream includes a header( ) block, object_metadata( ) blocks, and audio_frames( ) blocks. After the header( ) block is transmitted, the object_metadata( ) blocks and the audio_frames( ) blocks are transmitted alternately until the end of the bit stream. Furthermore, as shown in FIG. 5, the object_metadata( ) block includes metadata (object_metadatum( ) blocks), and the audio_frames( ) block includes audio objects (audio_frame( ) blocks).

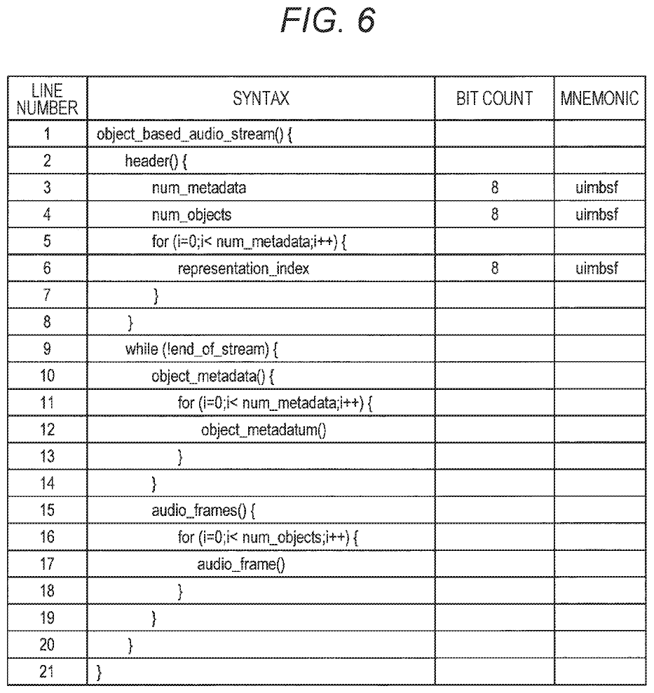

Details of the configuration example of the bit stream will be described with reference to FIG. 6. In FIG. 6, the header( ) block is shown in line numbers 2 to 8, the object_metadata( ) block is shown in line numbers 10 to 14, and the audio_frames( ) block is shown in line numbers 15 to 19.

In the header( ) block, “num_metadata” described in line number 3 indicates the number of pieces of metadata (the number of object_metadatum( ) blocks) included in the bit stream. Furthermore, “num_objects” described in line number 4 indicates the number of audio objects (the number of audio_frame( ) blocks) included in the bit stream. In addition, “representation_index” described in line number 6 indicates the index of video representation in video stream data (first stream data). The id attribute of a representation element of an MPD file to be used to reproduce video stream data and audio stream data can be specified by any character string. Therefore, “representation_index” is to be assigned an integer value starting from 0 in the order of description in the MPD file. Note that the value of “representation_index” is not limited thereto.

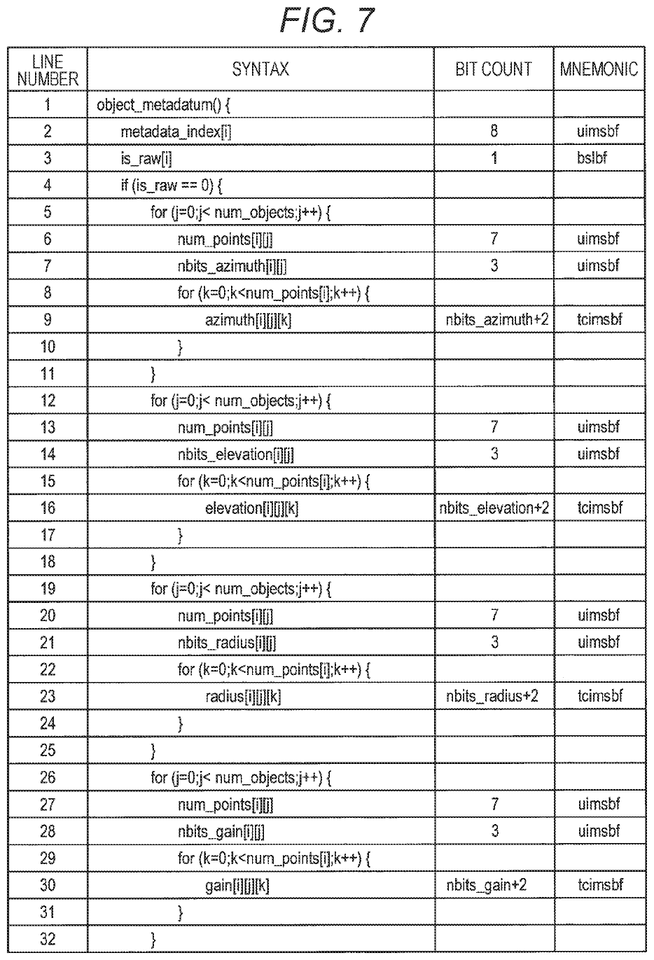

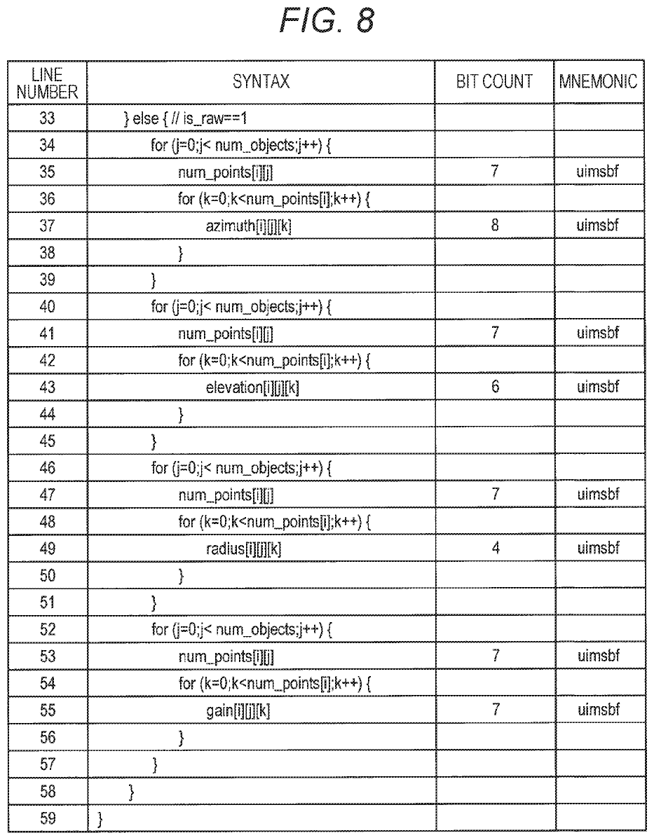

Next, a configuration example of the object_metadatum( ) block described in line number 12, in the object_metadata( ) block, will be described with reference to FIGS. 7 and 8.

In FIG. 7, “metadata_index” described in line number 2 indicates the index of the object_metadata( ) block. In a case where “metadata_index” satisfies the relationship “metadata_index=i”, metadata for generating a sound field corresponding to video representation of “representation_index[i]” are stored in the object_metadatum( ) block.

Furthermore, the audio_frames( ) block to which the metadata stored in the object_metadatum( ) block are applied can be time-divided, and “num_points” described in, for example, line number 6 indicates the number of divisions. In the reproduction time period of the audio_frames( ) block, metadata dividing points the number of which corresponds to “num_points” are equally generated (in other words, the reproduction time period of the audio_frames( ) block is divided into the number “num_points+1”).

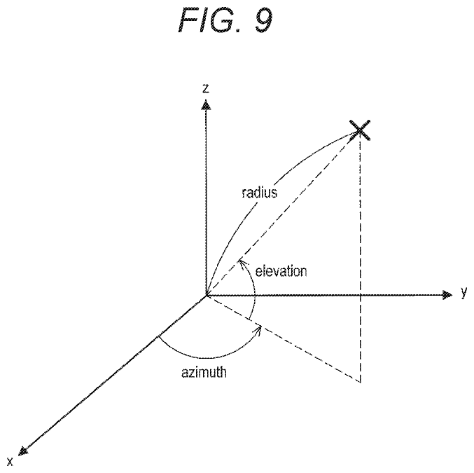

Furthermore, “azimuth” described in line number 9, “elevation” described in line number 16, and “radius” described in line number 23 each indicate position information on each audio object. As shown in FIG. 9, “azimuth” represents an azimuth in a spherical coordinate system, “elevation” represents an angle of elevation in the spherical coordinate system, and “radius” represents a radius in the spherical coordinate system. In addition, “gain” described in line number 30 represents the gain of each audio object.

The item “Is_raw” described in line number 3 is information indicating whether or not the values of “azimuth”, “elevation”, “radius”, and “gain” are difference values. For example, in a case where “is_raw” satisfies the relationship “is_raw=0”, these values are difference values, and in a case where “is_raw” satisfies the relationship “is_raw=1”, these values are not difference values (these values are true values (direct values)).

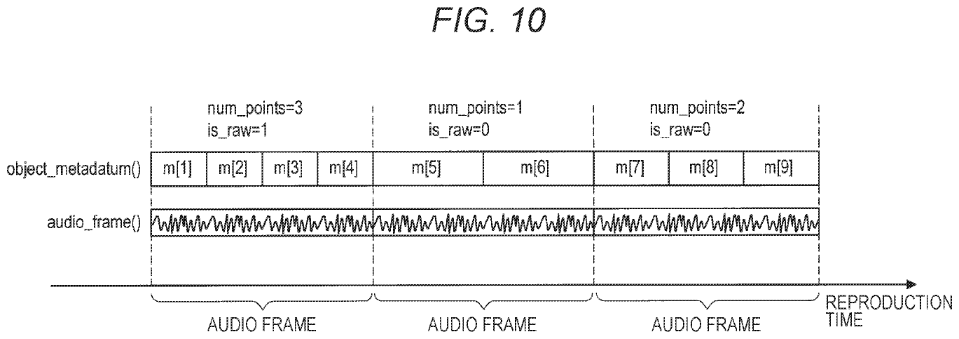

A difference value is derived for each audio object. Furthermore, derivation of difference values starts with a value of the last piece of metadata in the object_metadatum( ) block immediately before a point at which “is_raw” satisfies the relationship “is_raw=1”. Here, a more specific description will be given with reference to FIG. 10. In FIG. 10, “m[i]” (i=1, 2, . . . , 9) is a general term for each piece of metadata (“azimuth”, “elevation”, “radius”, and “gain”). The values of m[1] to m[4] are direct values (in other words, “is_raw” satisfies the relationship “is_raw=1”). The values of m[5] to m[9] are difference values (in other words, “is_raw” satisfies the relationship “is_raw=0”).

In this case, derivation of difference values of m[5] to m[9] starts with the value of m[4] that is the last piece of metadata in the object_metadatum( ) block immediately before a point at which “is_raw” satisfies the relationship “is_raw=1”. Therefore, m[5] is a difference value derived from m[4]. Similarly, m[6] is a difference value derived from m[5], and m[9] is a difference value derived from m[8].

The client apparatus 200 stores the value of metadata derived last, each time the object_metadatum( ) block is processed. Thus, the client apparatus 200 can derive the value of each piece of metadata indicated by a difference value as described above.

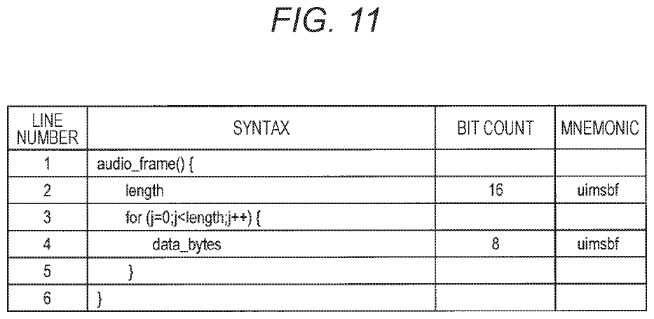

Next, a configuration example of the audio_frame( ) block described in line number 17 in FIG. 6, in the audio_frames( ) block, will be described with reference to FIG. 11.

The item “length” described in line number 2 indicates the data length of the following audio object. Furthermore, audio object data are to be stored in “data_bytes” described in line number 4. For example, audio_frames (1,024 audio samples) encoded by the MPEG4-AAC system can be stored in “data_bytes”. In a case where no specific audio_frame is defined as in the linear PCM system, a certain reproduction time period is used as a unit of time, and data required for the certain reproduction time period are stored in “data_bytes”.

(2.2. Example of MPEG-DASH Distribution Using Object-Based Audio)

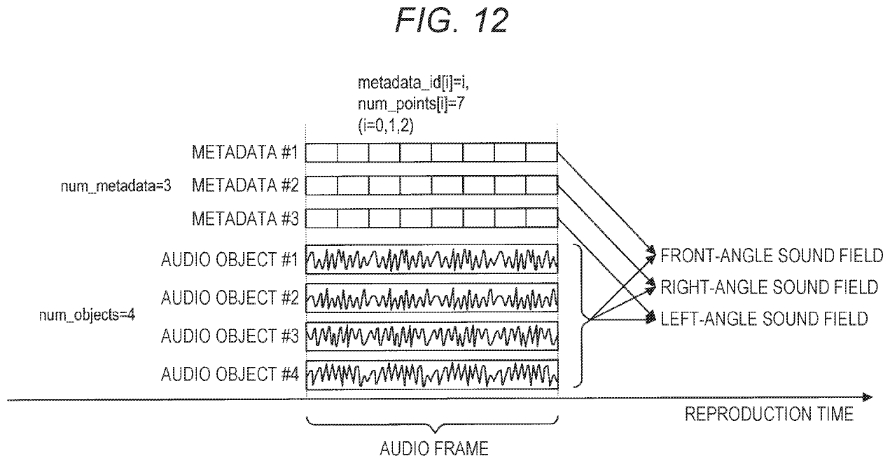

Next, an example of a case where MPEG-DASH distribution is performed by use of the object-based audio bit stream described above will be described with reference to FIG. 12.

For example, consider a piece of content in which three types of video/audio taken from the left angle, front angle, and right angle are provided for a specific object. In a case where a plurality of sound sources is present in the video, the distance from a user to each sound source, and the like differ from angle to angle. Therefore, it is preferable that sounds to be provided to the user also differ according to the angles.

For example, three bit streams encoded by H.265 (ISO/IEC 23008-2 HEVC) are prepared for video representation. In contrast, a single object-based audio bit stream is prepared for audio representation. Furthermore, it is assumed that an object-based audio bit stream contains three pieces of metadata (that is, “num_metadata” satisfies the relationship “num_metadata=3”) and four audio objects (that is, “num_objects” satisfies the relationship “num_objects=4”). Furthermore, in the example of FIG. 12, an audio_frame to which each piece of metadata is applied is time-divided into eight (that is, “num_points” satisfies the relationship “num_points=7”).

At this time, the client apparatus 200 can generate different sound fields by applying different metadata to a common audio object, and thus can represent a sound field following the switching of the video angles. More specifically, the client apparatus 200 can switch metadata at any timing. Therefore, in a case where, for example, video angles are switched by a user operation input, the client apparatus 200 can switch metadata at the timing at which the video angles are switched. As a result, the client apparatus 200 can represent a sound field following the switching of the video angles.

(2.3. Segmentation Method)

Next, described below is a method for segmentation of an object-based audio bit stream. Hereinafter, a case where segmentation is implemented by use of an MP4 (ISO/IEC 14496 Part 12 ISO base media file format) container will be described as an example. However, the segmentation method is not limited thereto.

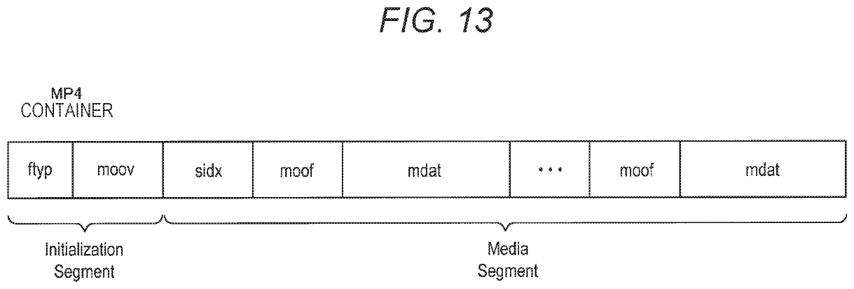

FIG. 13 shows a configuration example of an MP4 container in the case of storing an initialization segment and a media segment in the same MP4 container.

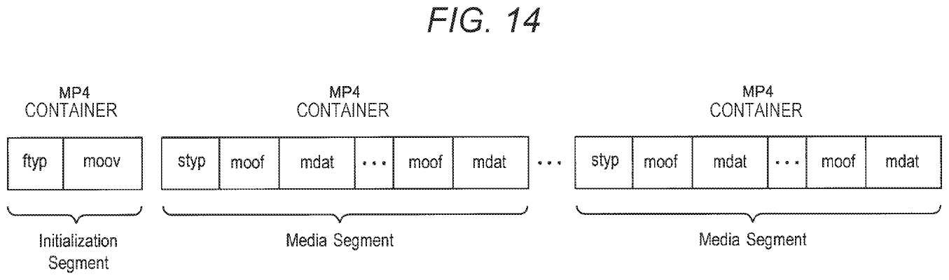

FIG. 14 shows a configuration example of each MP4 container in the case of storing an initialization segment and a media segment in different MP4 containers.

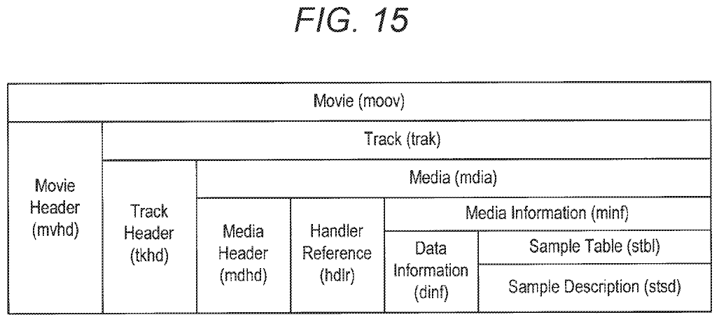

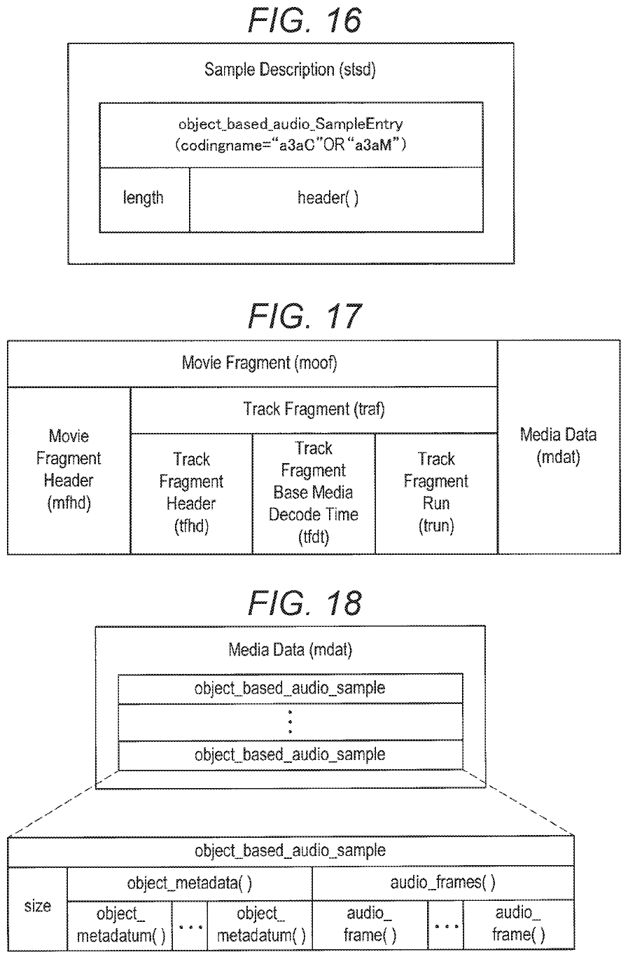

FIG. 15 shows a configuration of a Movie Box (moon). In both cases of FIGS. 13 and 14, it is assumed that the header( ) block of an object-based audio bit stream is stored in a Sample Description Box (stsd) under the Movie Box (moon). More specifically, as shown in FIG. 16, an object_based_audio_SampleEntry generated as a result of adding a length field indicating the data length of the entire header( ) block to the header( ) block is stored in the Sample Description Box (stsd) (note that it is assumed that a single object_based_audio_SampleEntry is stored in a single Sample Description Box (stsd)).

FIG. 17 shows a configuration of a Movie Fragment Box (moof) and a Media Data Box (mdat). Except for the header( ) block, the object-based audio bit stream is stored in the Media Data Box (mdat) in the media segment. Information for random access to the Media Data Box (mdat) (hereinafter referred to as “random access information”) is stored in the Movie Fragment Box (moof).

FIG. 18 shows a configuration of the Media Data Box (mdat). An object_based_audio_sample is stored in the Media Data Box (mdat). The object_based_audio_sample is generated as a result of adding a size field indicating an entire data length to the object_metadata( ) block and the audio_frame( ) block.

The data start position and data length of each object_based_audio_sample stored in the Media Data Box (mdat) are stored as random access information in a Track Fragment Run Box (trun) in the Movie Fragment Box (moof) shown in FIG. 17. Furthermore, time at which an audio object is output is referred to as a composition time stamp (CTS), and the CTS is also stored as random access information in the Track Fragment Run Box (trun).

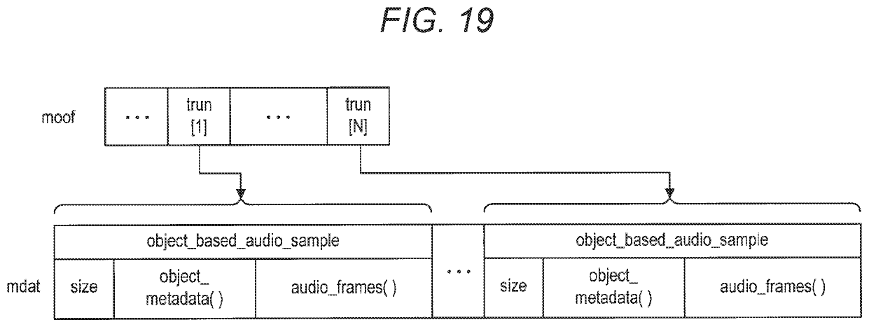

As a result of storing the above-described random access information in the Movie Fragment Box (moof), the client apparatus 200 can efficiently access object-based audio data by referring to these pieces of random access information during reproduction processing. For example, as shown in FIG. 19, the client apparatus 200 confirms the random access information stored in the Track Fragment Run Box (trun) in the Movie Fragment Box (moof), and then performs processing for reproducing an object_based_audio_sample corresponding to the Track Fragment Run Box (trun). Note that, for example, the reproduction time period of a single audio_frame( ) is approximately 21 milliseconds in audio data encoded in the MPEG4-AAC system at 48,000 Hz.

(2.4. Audio Representation Transmission Pattern)

Next, audio representation transmission patterns will be described. The server apparatus 100 according to the present disclosure can transmit audio representation in various patterns. Transmission patterns of cases 1 to 3 will be described below.

(Case 1)

First, case 1 will be described in which all metadata corresponding to video representation, switchable during a single audio representation are recorded and transmitted.

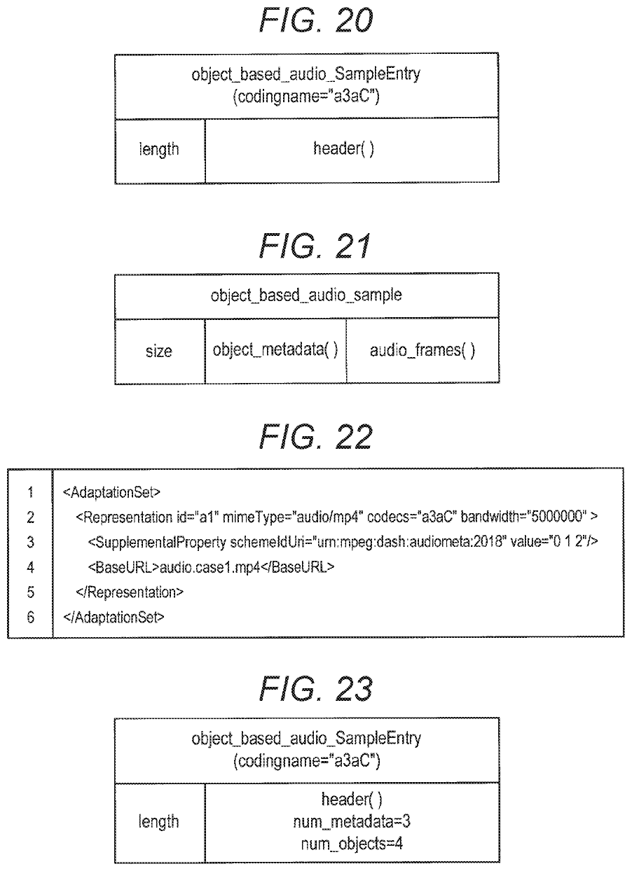

FIGS. 20 and 21 show schematic configurations of an object_based_audio_SampleEntry and an object_based_audio_sample for audio representation, respectively.

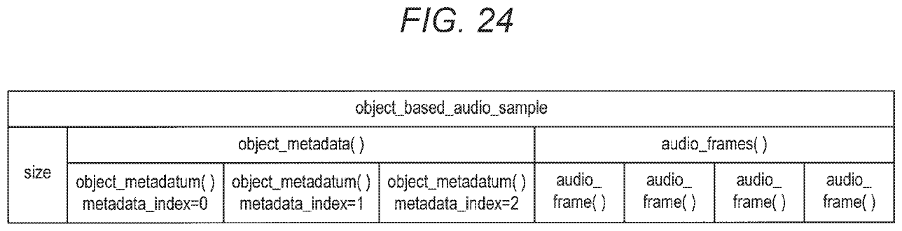

Furthermore, the client apparatus 200 acquires an MPD file that is control information, before reproduction processing, and performs processing for reproducing an object-based audio bit stream on the basis of the MPD file. FIG. 22 shows a specific example of an MPD file in a case where all metadata corresponding to video representation, switchable during a single audio representation are recorded and transmitted. In the example of FIG. 22, the audio representation is defined in line numbers 2 to 5 (Representation id=“a1”, num_objects=4, num_metadata=3 (metadata_index=0, 1, 2)). FIGS. 23 and 24 show configurations of the object_based_audio_SampleEntry and the object_based_audio_sample, respectively.

(Case 2)

Next, case 2 will be described in which an audio object and default metadata required at the start of reproduction are transmitted during a single audio representation and the other metadata are transmitted in other audio representations (note that it can be said that at least one piece of metadata to be used for the processing for reproducing audio stream data (second stream data) and an audio object (object data) can be stored in the same segment in cases 1 and 2).

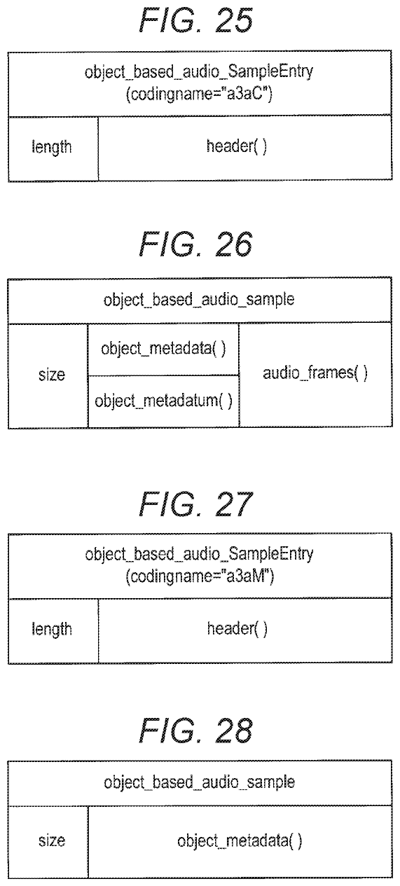

FIGS. 25 and 26 show schematic configurations of an object_based_audio_SampleEntry and an object_based_audio_sample, respectively, for audio representation in which audio objects and default metadata have been recorded.

FIGS. 27 and 28 show schematic configurations of an object_based_audio_SampleEntry and an object_based_audio_sample, respectively, for audio representation in which only metadata are recorded. Note that a plurality of object_metadatum( ) blocks may be stored in a single MP4 container, or a single object_metadatum( ) block may be stored in a single MP4 container.

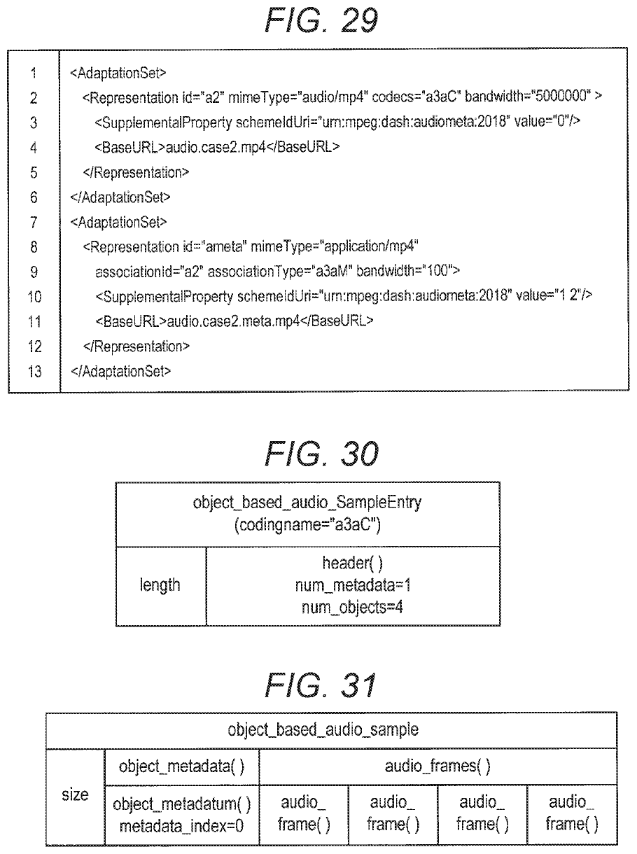

FIG. 29 shows a specific example of an MPD file to be used in this case. In the example of FIG. 29, the audio representation in which audio objects and default metadata are recorded is defined in line numbers 2 to 5 (Representation id=“a2”, num_objects=4, num_metadata=1 (metadata_index=0)). In addition, the audio representation in which only metadata are recorded is defined in line numbers 8 to 12 (Representation id=“ameta”, num_objects=0, num_metadata=2 (metadata_index=1, 2)).

Here, a mechanism for associating an audio object with metadata is necessary. This is because an audio object and at least some of metadata are transmitted in different audio representations in case 2 and case 3 to be described later. Therefore, the server apparatus 100 associates an audio object with metadata by using an “associationId” attribute and an “associationType” attribute in an MPD file. More specifically, the server apparatus 100 indicates that the audio representation relates to the association between the audio object and the metadata by describing “a3aM” in the “associationType” attribute described in line number 9 in FIG. 29. Moreover, the server apparatus 100 indicates that the audio representation is associated with an audio object in an audio representation having the Representation id attribute “a2” by describing “a2” in the “associationId” attribute of line number 9. This allows the client apparatus 200 to properly recognize the correspondence between an audio object and metadata also in cases 2 and 3. Note that the above is merely an example, and the server apparatus 100 may associate an audio object with metadata by using an attribute other than the “associationId” attribute or the “associationType” attribute.

FIGS. 30 and 31 show configurations of the object_based_audio_SampleEntry and the object_based_audio_sample, respectively, for the audio representation in which audio objects and default metadata are recorded.

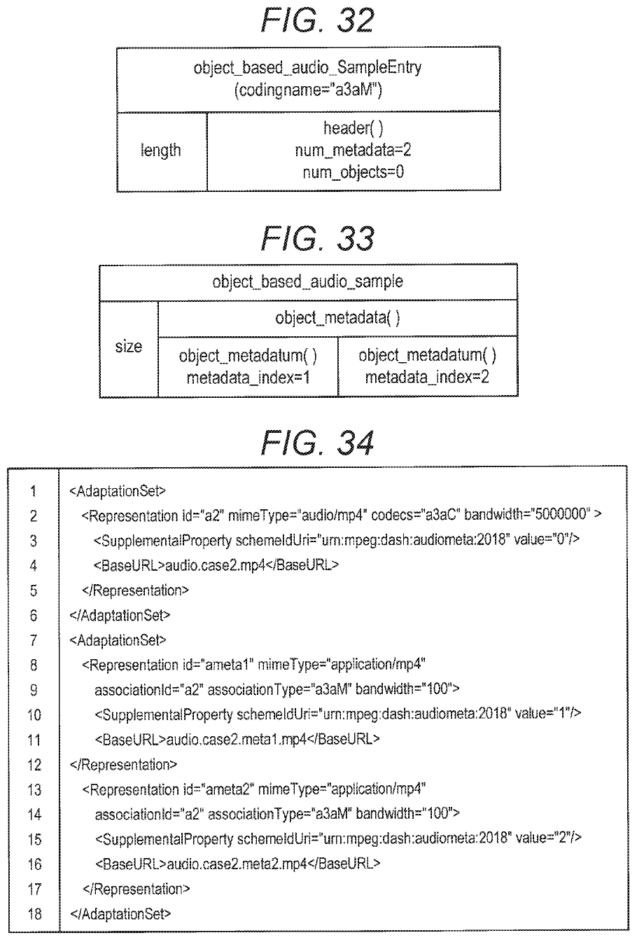

FIGS. 32 and 33 show configurations of the object_based_audio_SampleEntry and the object_based_audio_sample, respectively, for the audio representation in which only metadata are recorded.

Cases where two types of audio representations are transmitted have been described in FIGS. 29 to 33. However, the number of types of audio representations to be transmitted is not particularly limited. For example, three types of audio representations may be transmitted.

FIG. 34 shows a specific example of an MPD file to be used in a case where three types of audio representations are transmitted. In the example of FIG. 34, an audio representation in which audio objects and default metadata are recorded is defined in line numbers 2 to 5 (Representation id=“a2”, num_objects=4, num_metadata=1 (metadata_index=0)). Furthermore, a first type of audio representation in which only metadata are recorded is defined in line numbers 8 to 12 (Representation id=“ameta1”, num_objects=0, num_metadata=1 (metadata_index=1)). Moreover, a second type of audio representation in which only metadata are recorded is defined in line numbers 13 to 17 (Representation id=“ameta2”, num_objects=0, num_metadata=1 (metadata_index=2)).

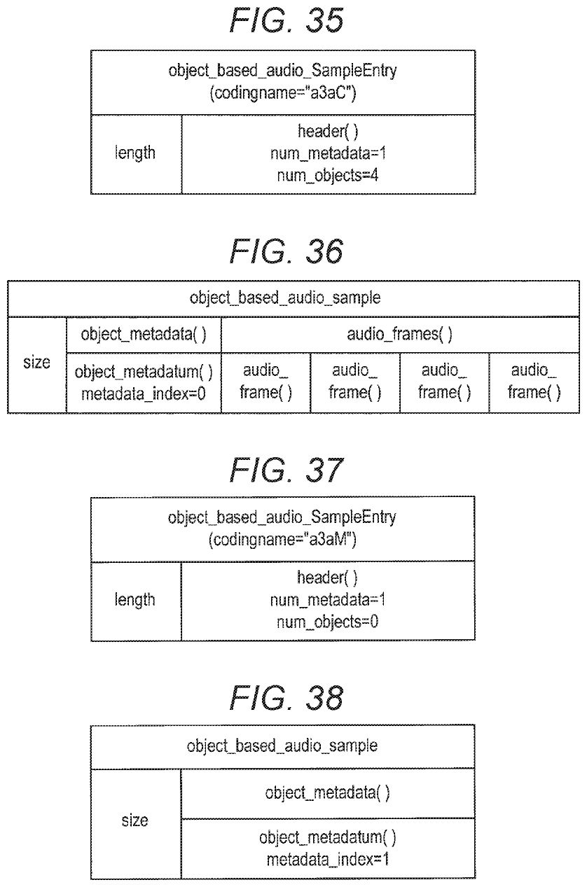

FIGS. 35 and 36 show configurations of an object_based_audio_SampleEntry and an object_based_audio_sample, respectively, for the audio representation in which audio objects and default metadata are recorded.

FIGS. 37 and 38 show configurations of an object_based_audio_SampleEntry and an object_based_audio_sample, respectively, for the first type of audio representation in which only metadata are recorded.

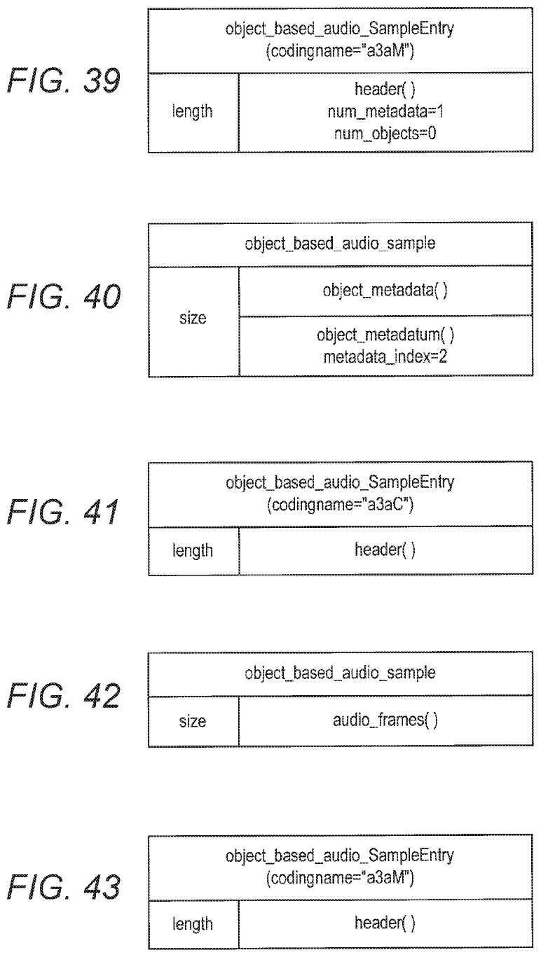

FIGS. 39 and 40 show configurations of an object_based_audio_SampleEntry and an object_based_audio_sample, respectively, for the second type of audio representation in which only metadata are recorded.

Case 3

Next, the following case will be described as case 3. An audio representation in which only an audio object is recorded is transmitted separately from an audio representation in which only metadata are recorded (note that it can be said that metadata to be used for the processing for reproducing audio stream data (second stream data) and an audio object (object data) can be stored in different segments in case 3).

FIGS. 41 and 42 show schematic configurations of an object_based_audio_SampleEntry and an object_based_audio_sample, respectively, for audio representation in which only audio objects are recorded.

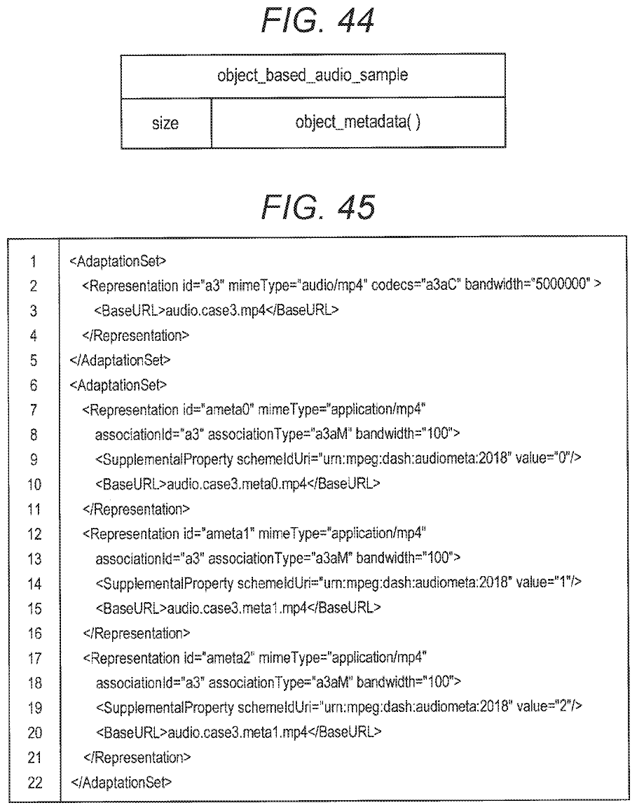

FIGS. 43 and 44 show schematic configurations of an object_based_audio_SampleEntry and an object_based_audio_sample, respectively, for audio representation in which only metadata are recorded.

FIG. 45 shows a specific example of an MPD file to be used in this case. In the example of FIG. 45, audio representation in which only audio objects are recorded is defined in line numbers 2 to 4 (Representation id=“a3”, num_objects=4, num_metadata=0). Furthermore, a first type of audio representation in which only metadata are recorded is defined in line numbers 7 to 11 (Representation id=“ameta0”, num_objects=0, num_metadata=1 (metadata_index=0)). In addition, a second type of audio representation in which only metadata are recorded is defined in line numbers 12 to 16 (Representation id=“ameta1”, num_objects=0, num_metadata=1 (metadata_index=1)). Moreover, a third type of audio representation in which only metadata are recorded is defined in line numbers 17 to 21 (Representation id=“ameta2”, num_objects=0, num_metadata=1 (metadata_index=2)).

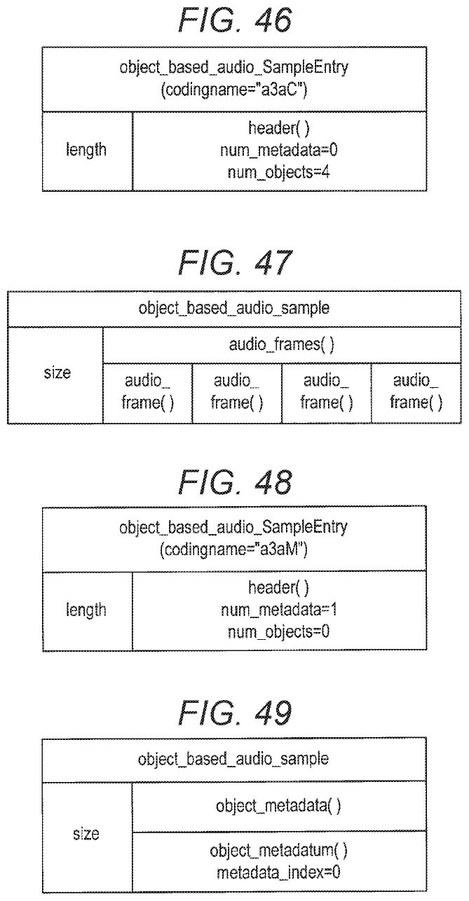

FIGS. 46 and 47 show configurations of an object_based_audio_SampleEntry and an object_based_audio_sample, respectively, for the audio representation in which only audio objects are recorded.

FIGS. 48 and 49 show configurations of an object_based_audio_SampleEntry and an object_based_audio_sample, respectively, for the first type of audio representation in which only metadata are recorded.

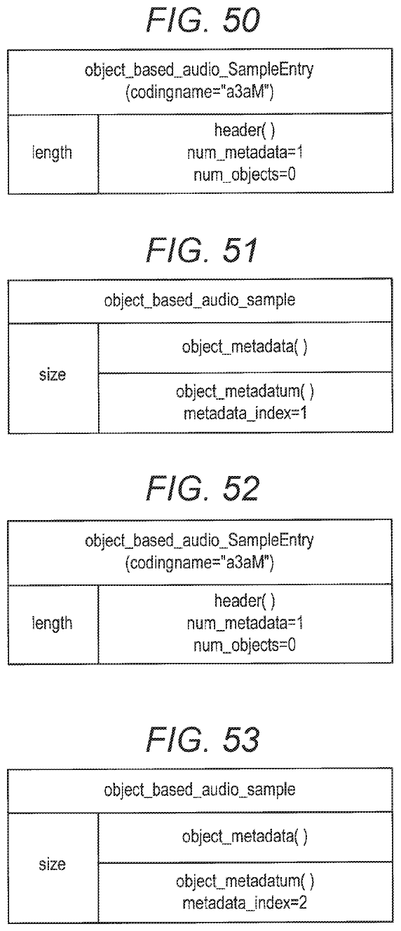

FIGS. 50 and 51 show configurations of an object_based_audio_SampleEntry and an object_based_audio_sample, respectively, for the second type of audio representation in which only metadata are recorded.

FIGS. 52 and 53 show configurations of an object_based_audio_SampleEntry and an object_based_audio_sample, respectively, for the third type of audio representation in which only metadata are recorded.

Each of cases 1 to 3 has been described above. When evaluated from the viewpoint of transmission efficiency, case 3 where audio representation in which only audio objects are recorded is transmitted separately from audio representation in which only metadata are recorded is the most desirable, and case 1 where all the metadata are recorded in a single audio representation is the least desirable. Meanwhile, the client apparatus 200 may fail to acquire metadata. When evaluated from this viewpoint, case 1 is the most desirable and case 3 is the least desirable, in contrast to the above. Furthermore, in case 2, all audio objects and default metadata are recorded in the same media segment. Therefore, case 2 has an advantage in that the client apparatus 200 does not fail in rendering while maintaining high transmission efficiency (the client apparatus 200 can perform rendering by using default metadata even in a case where the client apparatus 200 fails to acquire the other metadata).

(2.5. Metadata Switching Timing Signaling System) Next, a signaling system for metadata switching timing will be described. As described above, a timing at which video segments may be switched for each audio representation is referred to as a ConnectionPoint. Note that the ConnectionPoint refers to time when a first frame in each video segment is displayed, and the term “first frame in a video segment” refers to a first frame in the video segment in the order of presentation.

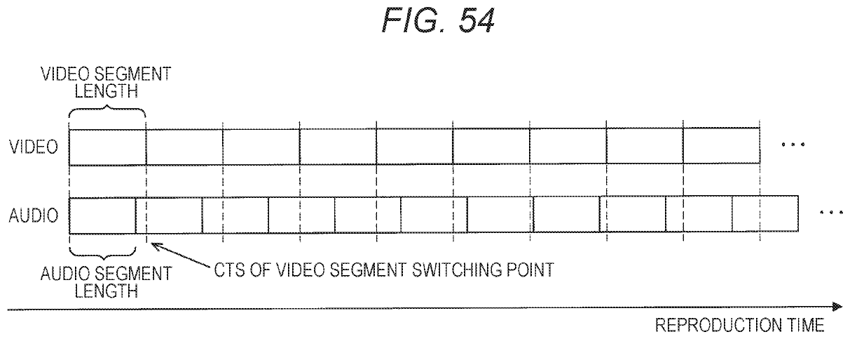

Here, a case where the length of an audio segment is set in such a way as to be smaller than the length of a video segment as shown in FIG. 54 will be described below as an example. In this case, the number of times metadata are switched in a single audio segment is one at maximum. Note that the present disclosure can be applied even in a case where the length of an audio segment is set in such a way as to be larger than the length of a video segment (metadata are just switched multiple times in a single audio segment).

In the present specification, the timing of switching video stream data (first stream data) is referred to as a ConnectionPoint, and the server apparatus 100 includes timing information regarding the ConnectionPoint in metadata to be used for reproducing audio stream data (second stream data). More specifically, the server apparatus 100 includes a connectionPointTimescale, a connectionPointOffset, and a connectionPointCTS as timing information in an MPD file to be used for reproducing audio stream data. The connectionPointTimescale is a time scale value (for example, a value representing a unit time and the like). The connectionPointOffset is a value of a media offset set in an elst box or a value of a presentationTimeOffset described in an MPD file. The connectionPointCTS is a value representing a CTS of the switching timing (time when the first frame in the video segment is displayed).

Then, when receiving the MPD file, the client apparatus 200 derives the ConnectionPoint by inputting the connectionPointTimescale, the connectionPointOffset, and the connectionPointCTS into Expression 1 below. As a result, the client apparatus 200 can derive the timing (ConnectionPoint) of switching video stream data with high accuracy (for example, in milliseconds).

$$\begin{matrix}[ Math . 1 ] & \\ \frac{connectionPointCTS - connectionPointOffset}{connectionPointTimescale} & ( Expression 1 )\end{matrix}$$

Here, the server apparatus 100 can describe the timing information in the MPD file by using various methods. For example, in a case where representation elements are described in the SegmentList format, the server apparatus 100 can generate an MPD file as shown in FIG. 55. More specifically, the server apparatus 100 can describe the connectionPointTimescale in line number 7, describe the connectionPointOffset in line number 8, and describe the connectionPointCTS as an attribute of each segment URL of each audio object in line numbers 9 to 12.

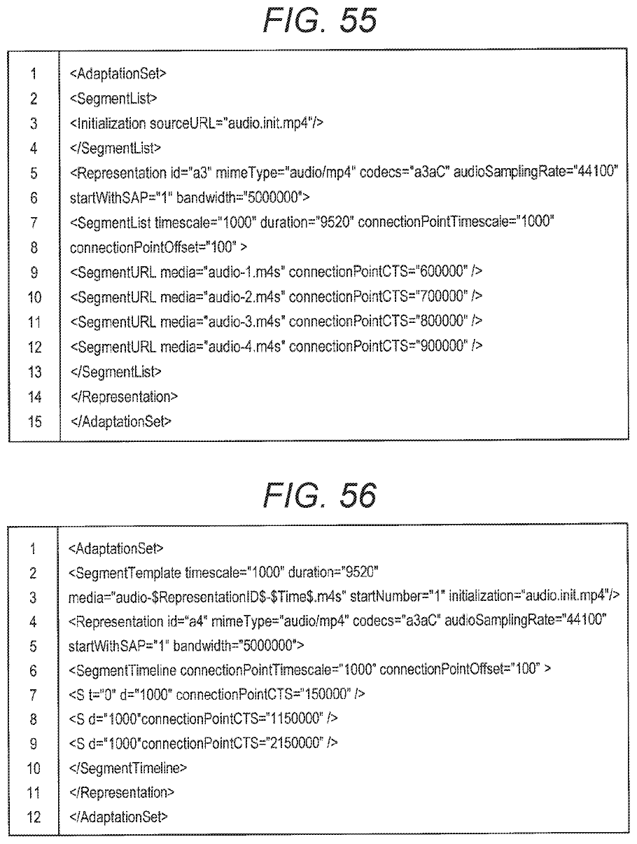

Furthermore, in a case where representation elements are described in the SegmentTemplate format, the server apparatus 100 can generate an MPD file as shown in FIG. 56. More specifically, the server apparatus 100 can provide a SegmentTimeline in line numbers 6 to 10, and describe the connectionPointTimescale, the connectionPointOffset, and the connectionPointCTS therein.

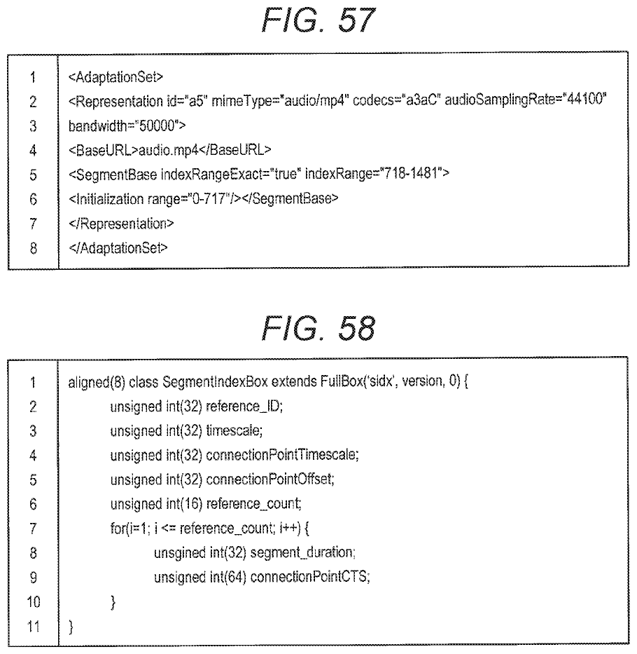

Furthermore, in a case where representation elements are described in the SegmentBase format, the server apparatus 100 can generate an MPD file as shown in FIG. 57. More specifically, the server apparatus 100 describes, in line number 5, an indexRange as information regarding the data position of a Segment Index Box (sidx). A Segment Index Box is recorded at the data position indicated by the indexRange starting from the head of the MP4 container. The server apparatus 100 describes the connectionPointTimescale, the connectionPointOffset, and the connectionPointCTS in the Segment Index Box.

FIG. 58 is a specific example of the Segment Index Box. The server apparatus 100 can describe the connectionPointTimescale in line number 4, the connectionPointOffset in line number 5, and the connectionPointCTS in line number 9. In a case where no ConnectionPoint exists in a corresponding audio segment, the server apparatus 100 can provide information to that effect by setting a predetermined data string (for example, “0xFFFFFFFFFFFFFFFF” and the like) as a connectionPointCTS.

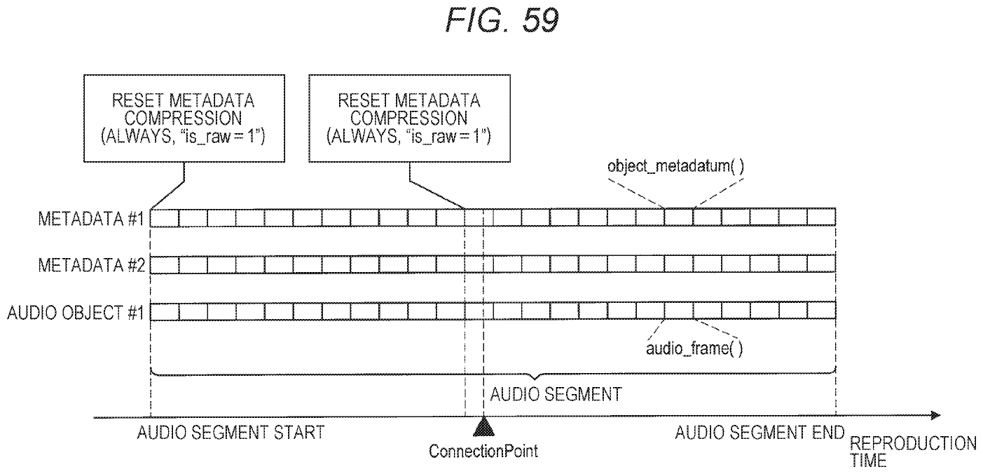

Note that the server apparatus 100 sets a direct value as metadata (is_raw=1) in an object_metadatum( ) block corresponding to the beginning of the audio segment and in an object_metadatum( ) block corresponding to time including a CTS indicated by the ConnectionPoint, as shown in FIG. 59. This is because there is a possibility that the switching of “metadata_index” occurs in the object_metadatum( ) blocks.

### 3. EMBODIMENT OF PRESENT DISCLOSURE

Details of the present disclosure have been described above. Hereinafter, an embodiment of the present disclosure will be described.

(3.1. Example of System Configuration)

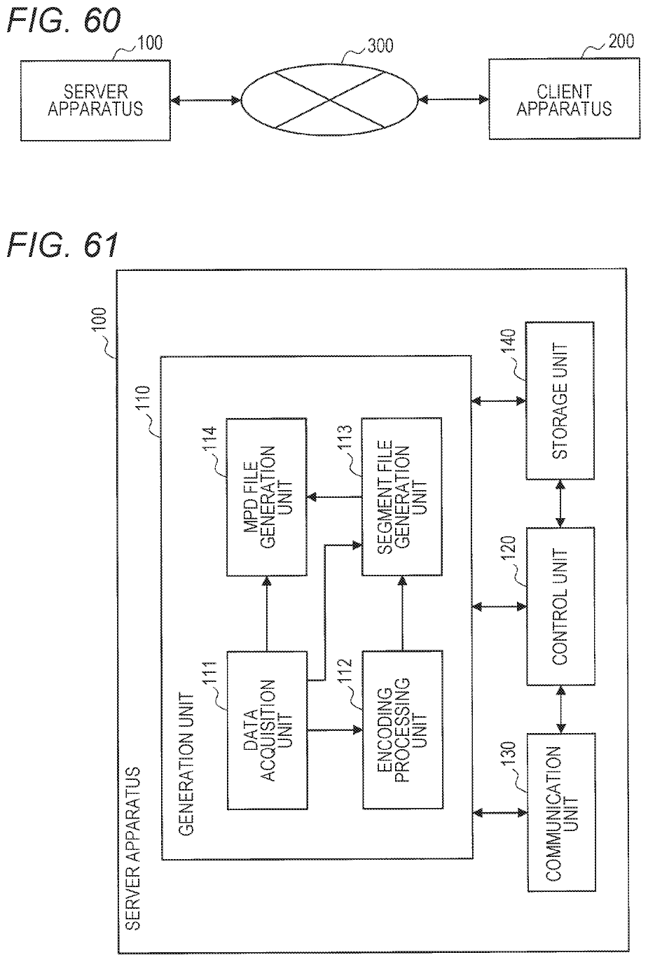

First, a configuration example of an information processing system according to the embodiment of the present disclosure will be described with reference to FIG. 60.

As shown in FIG. 60, the information processing system according to the present embodiment includes the server apparatus 100 and the client apparatus 200. Then, the server apparatus 100 and the client apparatus 200 are connected to each other via the Internet 300.

The server apparatus 100 is an information processing apparatus (transmission apparatus) that distributes various types of content to the client apparatus 200 on the basis of MPEG-DASH. More specifically, in response to a request from the client apparatus 200, the server apparatus 100 transmits an MPD file, video stream data (first stream data), audio stream data (second stream data), and the like to the client apparatus 200.

The client apparatus 200 is an information processing apparatus (receiving apparatus) that plays various types of content on the basis of MPEG-DASH. More specifically, the client apparatus 200 acquires an MPD file from the server apparatus 100, acquires video stream data, audio stream data, and the like from the server apparatus 100 on the basis of the MPD file, and performs a decoding process to play video content and audio content.

A configuration example of the information processing system according to the present embodiment has been described above. Note that the configuration described above with reference to FIG. 60 is merely an example, and the configuration of the information processing system according to the present embodiment is not limited to such an example. For example, all or some of the functions of the server apparatus 100 may be provided in the client apparatus 200 or another external device. For example, software that provides all or some of the functions of the server apparatus 100 (for example, a WEB application in which a predetermined application programming interface (API) is used, or the like) may be implemented on the client apparatus 200. Furthermore, instead, all or some of the functions of the client apparatus 200 may be provided in the server apparatus 100 or another external device. The configuration of the information processing system according to the present embodiment can be flexibly modified according to specifications and operation.

Here, in particular, processing regarding audio stream data that are the second stream data is the point of the present embodiment. Thus, the processing regarding audio stream data will be mainly described below.

(3.2. Functional Configuration Example of Server Apparatus 100)

The system configuration example of the information processing system according to the present embodiment has been described above. Next, an example of the functional configuration of the server apparatus 100 will be described with reference to FIG. 61.

As shown in FIG. 61, the server apparatus 100 includes a generation unit 110, a control unit 120, a communication unit 130, and a storage unit 140.

The generation unit 110 is a functional element that generates audio stream data (second stream data). As shown in FIG. 61, the generation unit 110 includes a data acquisition unit 111, an encoding processing unit 112, a segment file generation unit 113, and an MPD file generation unit 114, and controls these functional elements to implement generation of audio stream data.

The data acquisition unit 111 is a functional element that acquires an audio object (material sound) to be used to generate the second stream data. The data acquisition unit 111 may acquire an audio object from the server apparatus 100, or may acquire an audio object from an external device connected to the server apparatus 100. The data acquisition unit 111 supplies the acquired audio object to the encoding processing unit 112.

The encoding processing unit 112 is a functional element that generates audio stream data by encoding the audio object supplied from the data acquisition unit 111 and metadata including, for example, position information on each audio object input from the outside. The encoding processing unit 112 supplies the audio stream data to the segment file generation unit 113.

The segment file generation unit 113 is a functional element that generates an audio segment (initialization segment, media segment, or the like) that is a unit of data capable of being distributed as audio content. More specifically, the segment file generation unit 113 generates an audio segment by converting the audio stream data supplied from the encoding processing unit 112 into files in segment units. In addition, the segment file generation unit 113 includes timing information regarding the timing of switching video stream data (first stream data), and the like in a Segment Index Box (sidx) of the audio stream data (second stream data).

The MPD file generation unit 114 is a functional element that generates an MPD file. In the present embodiment, the MPD file generation unit 114 includes the timing information regarding the timing of switching the video stream data (first stream data), and the like in an MPD file (a kind of metadata) to be used for reproducing the audio stream data (second stream data).

The control unit 120 is a functional element that controls overall processing to be performed by the server apparatus 100, in a centralized manner. For example, the control unit 120 can control activation and deactivation of each constituent element on the basis of request information or the like received from the client apparatus 200 via the communication unit 130. Note that details of control to be performed by the control unit 120 are not particularly limited. For example, the control unit 120 may control processing to be generally performed in a general-purpose computer, a PC, a tablet PC, or the like.

The communication unit 130 is a functional element that performs various types of communication with the client apparatus 200 (also functions as a transmission unit). For example, the communication unit 130 receives request information from the client apparatus 200, and transmits an MPD file, audio stream data, video stream data, or the like to the client apparatus 200 in response to the request information. Note that details of communication to be performed by the communication unit 130 are not limited thereto.

The storage unit 140 is a functional element in which various types of information are stored. For example, MPD files, audio objects, metadata, audio stream data, video stream data, or the like are stored in the storage unit 140. In addition, programs, parameters, and the like to be used by each functional element of the server apparatus 100 are stored in the storage unit 140. Note that information to be stored in the storage unit 140 is not limited thereto.

An example of the functional configuration of the server apparatus 100 has been described above. Note that the functional configuration described above with reference to FIG. 61 is merely an example, and the functional configuration of the server apparatus 100 is not limited to such an example. For example, the server apparatus 100 does not necessarily have to include all the functional elements shown in FIG. 61. Furthermore, the functional configuration of the server apparatus 100 can be flexibly modified according to specifications and operation.

(3.3. Functional Configuration Example of Client Apparatus 200)

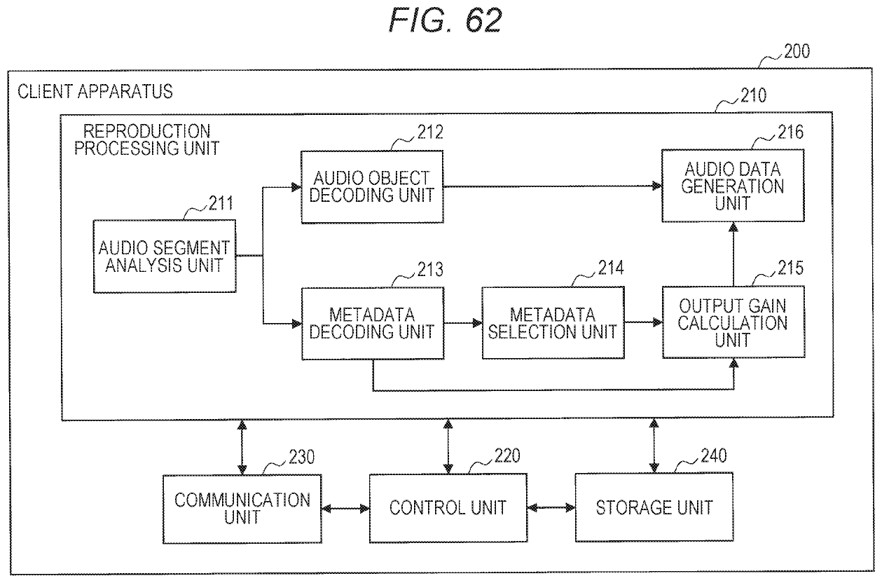

An example of the functional configuration of the server apparatus 100 has been described above. Next, an example of the functional configuration of the client apparatus 200 will be described with reference to FIG. 62.

As shown in FIG. 62, the client apparatus 200 includes a reproduction processing unit 210, a control unit 220, a communication unit 230, and a storage unit 240.

The reproduction processing unit 210 is a functional element that performs processing for reproducing audio stream data (second stream data) on the basis of metadata corresponding to the audio stream data. As shown in FIG. 62, the reproduction processing unit 210 includes an audio segment analysis unit 211, an audio object decoding unit 212, a metadata decoding unit 213, a metadata selection unit 214, an output gain calculation unit 215, and an audio data generation unit 216. The reproduction processing unit 210 controls these functional elements to implement the processing for reproducing audio stream data.

The audio segment analysis unit 211 is a functional element that analyzes an audio segment. As described above, audio segments include initialization segments and media segments, each of which will be described below.

A process of analyzing an initialization segment will be described as follows. The audio segment analysis unit 211 reads lists of “num_objects”, “num_metadata”, and “representation_index” by analyzing a header( ) block in a Sample Description Box (stsd) under a Movie Box (moon). Furthermore, the audio segment analysis unit 211 pairs “representation_index” with “metadata_index”. Moreover, in a case where representation elements are described in the SegmentBase format in the MPD file, the audio segment analysis unit 211 reads a value (timing information) regarding a ConnectionPoint from the Segment Index Box (sidx).

To describe a process of analyzing a media segment, the audio segment analysis unit 211 repeats a process of reading a single audio_frame( ) block in an audio_frames( ) block and supplying the read audio_frame( ) block to the audio object decoding unit 212 a specific number of times, the specific number corresponding to the number of audio objects (that is, the value of “num_objects”).

Furthermore, the audio segment analysis unit 211 repeats a process of reading an object_metadatum( ) block in an object_metadata( ) block and supplying the read object_metadatum( ) block to the metadata decoding unit 213 a specific number of times, the specific number corresponding to the number of pieces of metadata (that is, the value of “num_metadata”). At this time, the audio segment analysis unit 211 searches for “representation_index” in the header( ) block on the basis of, for example, the index of video representation selected by a user of the client apparatus 200. Thus, the audio segment analysis unit 211 obtains “metadata_index” corresponding to the “representation_index”, and selectively reads an object_metadata( ) block containing the “metadata_index”.

The audio object decoding unit 212 is a functional element that decodes an audio object. For example, the audio object decoding unit 212 repeats a process of decoding an audio signal encoded by the MPEG4-AAC system to output PCM data and supplying the PCM data to the audio data generation unit 216 a specific number of times, the specific number corresponding to the number of audio objects (that is, the value of “num_objects”). Note that a decoding method to be used by the audio object decoding unit 212 corresponds to an encoding method to be used by the server apparatus 100, and is not particularly limited.

The metadata decoding unit 213 is a functional element that decodes metadata. More specifically, the metadata decoding unit 213 analyzes an object_metadatum( ) block, and reads position information (for example, “azimuth”, “elevation”, “radius”, and “gain”).

At this time, in a case where “is_raw” satisfies the relationship “is_raw=1”, these values are not difference values (these values are true values (direct values)). Therefore, the metadata decoding unit 213 supplies the output gain calculation unit 215 with the read “azimuth”, “elevation”, “radius”, and “gain” as they are. Meanwhile, in a case where “is_raw” satisfies the relationship “is_raw=0”, these values are difference values. Therefore, the metadata decoding unit 213 adds the read “azimuth”, “elevation”, “radius”, and “gain” to previously read values, and supplies values obtained as a result of the addition to the output gain calculation unit 215.

The metadata selection unit 214 is a functional element that switches metadata to be used for reproducing audio stream data (second stream data) to metadata corresponding to video stream data provided after the switching, at a timing at which video stream data (first stream data) are switched. More specifically, the metadata selection unit 214 confirms whether or not time at which reproduction is performed (reproduction time) is at the ConnectionPoint or earlier, and in a case where the reproduction time is at the ConnectionPoint or earlier, metadata provided before the switching are selected as metadata to be used for reproduction. Meanwhile, in a case where the reproduction time is later than the ConnectionPoint, metadata provided after the switching are selected as the metadata to be used for reproduction. The metadata selection unit 214 supplies the selected metadata (position information, and the like) to the output gain calculation unit 215.

The output gain calculation unit 215 is a functional element that calculates speaker output gain for each audio object on the basis of the metadata (position information and the like) supplied from the metadata decoding unit 213. The output gain calculation unit 215 supplies information regarding the calculated speaker output gain to the audio data generation unit 216.

The audio data generation unit 216 is a functional element that generates audio data to be output from each speaker. More specifically, the audio data generation unit 216 generates audio data to be output from each speaker by applying the speaker output gain calculated by the output gain calculation unit 215 to the PCM data for each audio object supplied from the audio object decoding unit 212.

The control unit 220 is a functional element that controls overall processing to be performed by the client apparatus 200, in a centralized manner. For example, the control unit 220 acquires an MPD file from the server apparatus 100 via the communication unit 230. Then, the control unit 220 analyzes the MPD file, and supplies a result of the analysis to the reproduction processing unit 210. In particular, in a case where representation elements of the MPD file are described in the SegmentTemplate format or the SegmentList format, the control unit 220 acquires a value (timing information) related to the ConnectionPoint, and supplies the acquired value to the reproduction processing unit 210. Furthermore, the control unit 220 acquires audio stream data (second stream data) and video stream data (first stream data) from the server apparatus 100 via the communication unit 230, and supplies “representation_index” and the like to the reproduction processing unit 210.

Moreover, the control unit 220 acquires an instruction to switch audio stream data and video stream data on the basis of a user input made by use of an input unit (not shown) such as a mouse or a keyboard. In particular, when the video stream data are switched, the control unit 220 acquires “representation_index”, and supplies the “representation_index” to the reproduction processing unit 210.

Note that details of control to be performed by the control unit 220 are not particularly limited. For example, the control unit 220 may control processing to be generally performed in a general-purpose computer, a PC, a tablet PC, or the like.

The communication unit 230 is a functional element that performs various types of communication with the server apparatus 100 (also functions as a receiving unit). For example, the communication unit 230 transmits request information to the server apparatus 100 on the basis of a user input or the like, and receives an MPD file, audio stream data, video stream data, and the like transmitted from the server apparatus 100 in response to the request information. Note that details of communication to be performed by the communication unit 230 are not limited thereto.

The storage unit 240 is a functional element in which various types of information is stored. For example, MPD files, audio stream data, video stream data, and the like provided from the server apparatus 100 are stored in the storage unit 240. In addition, programs, parameters, and the like to be used by each functional element of the client apparatus 200 are stored in the storage unit 240. Note that information to be stored in the storage unit 240 is not limited thereto.

An example of the functional configuration of the client apparatus 200 has been described above. Note that the functional configuration described above with reference to FIG. 62 is merely an example, and the functional configuration of the client apparatus 200 is not limited to such an example. For example, the client apparatus 200 does not necessarily have to include all the functional elements shown in FIG. 62. Furthermore, the functional configuration of the client apparatus 200 can be flexibly modified according to specifications and operation.

(3.4. Processing Flow Example of Client Apparatus 200)

An example of the functional configuration of the client apparatus 200 has been described above. Next, an example of a processing flow of the client apparatus 200 will be described.

(Example of Processing Flow to be Performed in Case where No Switching Occurs)

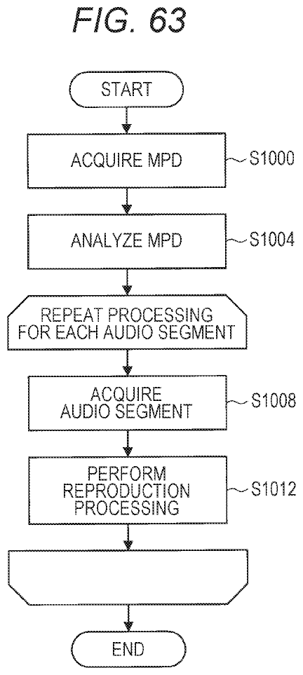

First, a specific example of the flow of processing for reproducing audio stream data to be performed by the client apparatus 200 in a case where the switching of video stream data and audio stream data does not occur will be described with reference to FIG. 63.

In step S1000, the control unit 220 of the client apparatus 200 acquires an MPD file from the server apparatus 100 via the communication unit 230. In step S1004, the control unit 220 analyzes the acquired MPD file.

Then, each functional element of the client apparatus 200 repeats processing of steps S1008 to S1012 for each audio segment, so that a series of processing steps is completed. More specifically, each functional element of the client apparatus 200 performs processing for acquiring an audio segment in step S1008, and performs processing for reproducing the acquired audio segment in step S1012. Thus, a series of processing steps is completed.

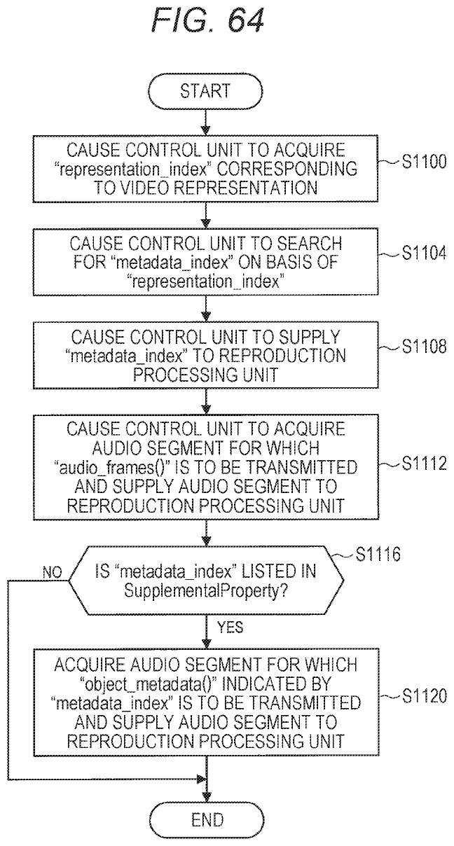

Next, a specific example of the flow of processing for acquiring an audio segment, which is performed in step S1008 of FIG. 63, will be described with reference to FIG. 64.

In step S1100, the control unit 220 of the client apparatus 200 acquires “representation_index” corresponding to video representation. In step S1104, the control unit 220 searches for “metadata_index” contained in an object_metadatum( ) block on the basis of the acquired “representation_index”. In step S1108, the control unit 220 supplies the “metadata_index” acquired in the search to the reproduction processing unit 210.

In step S1112, the control unit 220 acquires an audio segment for which an audio_frames( ) block is to be transmitted, and supplies the audio segment to the reproduction processing unit 210. Then, in a case where the “metadata_index” is listed in SupplementalProperty of the MPD file (step S1116/Yes), the control unit 220 acquires, in step S1120, an audio segment for which an object_metadata( ) block indicated by the “metadata_index” is to be transmitted, and supplies the audio segment to the reproduction processing unit 210. Thus, the processing for acquiring an audio segment is completed. In a case where the “metadata_index” is not listed in the SupplementalProperty of the MPD file (step S1116/No), the processing for acquiring an audio segment described in step S1120 is not performed, and a series of processing steps ends.

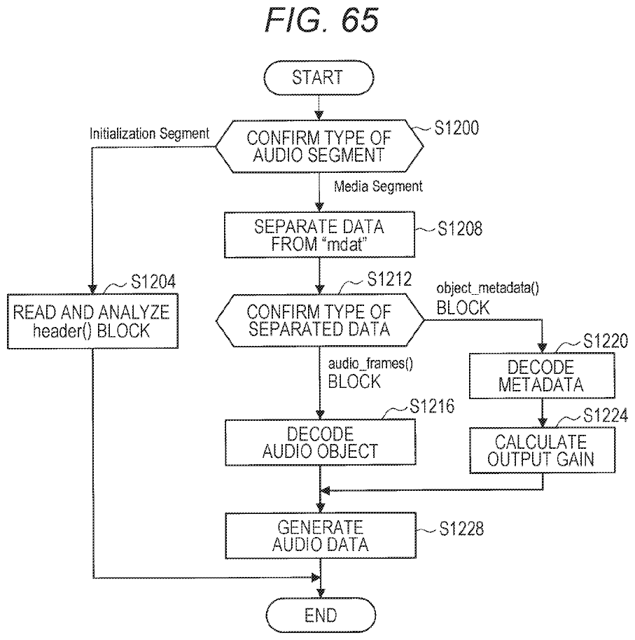

Next, a specific example of the flow of processing for reproducing an audio segment, which is performed in step S1012 of FIG. 63, will be described with reference to FIG. 65.

In step S1200, the audio segment analysis unit 211 of the client apparatus 200 confirms the type of the audio segment acquired by the control unit 220. In a case where the type of the audio segment acquired by the control unit 220 is “initialization segment”, the audio segment analysis unit 211 reads lists of “num_objects”, “num_metadata”, and “representation_index” by reading a header( ) block from a Sample Description Box (stsd) under a Movie Box (moon) and analyzing the header( ) block in step S1204. Furthermore, the audio segment analysis unit 211 pairs “representation_index” with “metadata_index”.

In a case where the type of the audio segment acquired by the control unit 220 is “media segment”, the audio segment analysis unit 211 separates data from a Media Data Box (mdat) in the media segment in step S1208. In step S1212, the audio segment analysis unit 211 confirms the type of the separated data. In a case where the type of the separated data is “audio_frames( ) block”, the audio segment analysis unit 211 reads an audio_frame( ) block in the audio_frames( ) block, and supplies the read audio_frame( ) block to the audio object decoding unit 212, so that the audio object decoding unit 212 decodes an audio object, in step S1216.

In a case where the type of the separated data is “object_metadata( ) block” in step S1212, the audio segment analysis unit 211 reads an object_metadatum( ) block in the object_metadata( ) block, and supplies the read object_metadatum( ) block to the metadata decoding unit 213, so that the metadata decoding unit 213 decodes metadata, in step S1220. In step S1224, the output gain calculation unit 215 calculates speaker output gain for each audio object on the basis of position information supplied from the metadata decoding unit 213.

Then, in step S1228, the audio data generation unit 216 generates audio data to be output from each speaker by applying the speaker output gain calculated by the output gain calculation unit 215 to PCM data for each audio object supplied from the audio object decoding unit 212. Thus, the processing for reproducing an audio segment is completed.

(Example of Processing Flow to be Performed in Case where Switching Occurs)

Next, the following describes the flow of processing to be performed in a case where the switching of video stream data and audio stream data occurs. Even in a case where both video stream data and audio stream data are switched, the flow of processing for reproducing audio stream data to be performed by the client apparatus 200 may be similar to the specific example shown in FIG. 63, and thus description thereof is omitted.

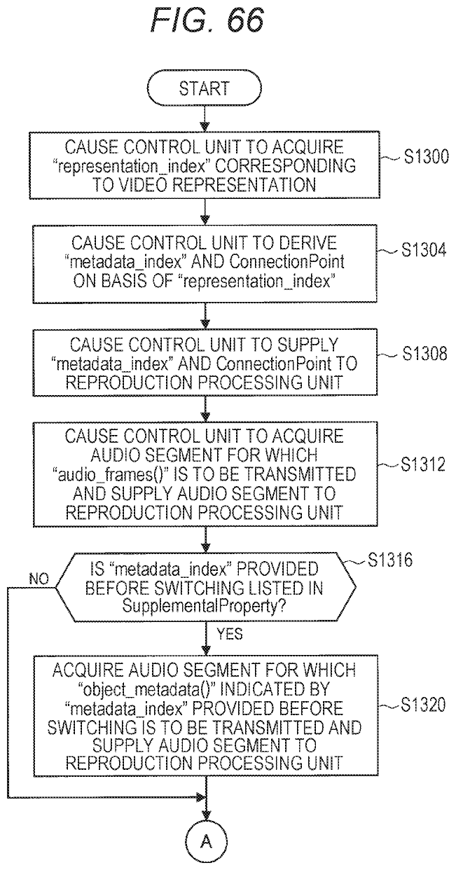

A specific example of the flow of processing for acquiring an audio segment, which is performed in step S1008 of FIG. 63, will be described with reference to FIG. 66.

In step S1300, the control unit 220 of the client apparatus 200 acquires “representation_index” corresponding to video representation. In step S1304, the control unit 220 derives “metadata_index” and a ConnectionPoint on the basis of the acquired “representation_index”. In step S1308, the control unit 220 supplies the derived “metadata_index” and ConnectionPoint to the reproduction processing unit 210.

In step S1312, the control unit 220 acquires an audio segment for which an audio_frames( ) block is to be transmitted, and supplies the audio segment to the reproduction processing unit 210. Then, in a case where “metadata_index” provided before switching is listed in the SupplementalProperty of the MPD file (step S1316/Yes), the control unit 220 acquires, in step S1320, an audio segment for which an object_metadata( ) block indicated by the “metadata_index” provided before the switching is to be transmitted, and supplies the audio segment to the reproduction processing unit 210. In a case where the “metadata_index” provided before the switching is not listed in the SupplementalProperty of the MPD file (step S1316/No), the processing of step S1320 is omitted.

Then, in a case where “metadata_index” provided after the switching is listed in the SupplementalProperty of the MPD file (step S1324/Yes), the control unit 220 acquires, in step S1328, an audio segment for which an object_metadata( ) block indicated by the “metadata_index” provided after the switching is to be transmitted, and supplies the audio segment to the reproduction processing unit 210. Thus, the processing for acquiring an audio segment is completed. In a case where the “metadata_index” provided after the switching is not listed in the SupplementalProperty of the MPD file (step S1324/No), processing of step S1328 is omitted and a series of processing steps ends.

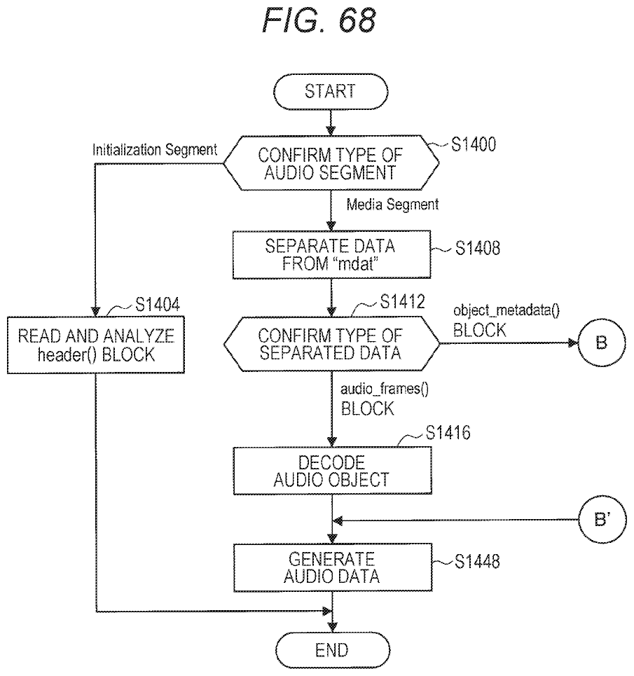

Next, a specific example of the flow of processing for reproducing an audio segment, which is performed in step S1012 of FIG. 63, will be described with reference to FIG. 68.

In step S1400, the audio segment analysis unit 211 of the client apparatus 200 confirms the type of the audio segment acquired by the control unit 220. In a case where the type of the audio segment acquired by the control unit 220 is “initialization segment”, the audio segment analysis unit 211 reads lists of “num_objects”, “num_metadata”, and “representation_index” by reading a header( ) block from a Sample Description Box (stsd) under a Movie Box (moon) and analyzing the header( ) block in step S1404. Furthermore, the audio segment analysis unit 211 pairs “representation_index” with “metadata_index”.

In a case where the type of the audio segment acquired by the control unit 220 is “media segment”, the audio segment analysis unit 211 separates data from a Media Data Box (mdat) in the media segment in step S1408. In step S1412, the audio segment analysis unit 211 confirms the type of the separated data. In a case where the type of the separated data is “audio_frames( ) block”, the audio segment analysis unit 211 reads an audio_frame( ) block in the audio_frames( ) block, and supplies the read audio_frame( ) block to the audio object decoding unit 212, so that the audio object decoding unit 212 decodes an audio object, in step S1416.

In a case where the type of the separated data is “object_metadata( ) block” in step S1412, the audio segment analysis unit 211 reads an object_metadatum( ) block provided before switching, and supplies the read object_metadatum( ) block to the metadata decoding unit 213, so that the metadata decoding unit 213 decodes metadata, in step S1420.

In a case where metadata provided after the switching do not exist in the same audio segment (step S1424/No), the audio segment analysis unit 211 reads, in step S1428, an audio segment containing the metadata provided after the switching, which has been acquired by the control unit 220.

In step S1432, the audio segment analysis unit 211 separates data from a Media Data Box (mdat) in the media segment. In step S1436, the audio segment analysis unit 211 reads an object_metadatum( ) block in an object_metadata( ) block, and supplies the read object_metadatum( ) block to the metadata decoding unit 213, so that the metadata decoding unit 213 decodes the metadata provided after the switching.

In step S1440, the metadata selection unit 214 selects metadata by using a predetermined method (a specific example of the method will be described later). In step S1444, the output gain calculation unit 215 calculates speaker output gain for each audio object on the basis of position information supplied from the metadata decoding unit 213.

Then, in step S1448, the audio data generation unit 216 generates audio data to be output from each speaker by applying the speaker output gain calculated by the output gain calculation unit 215 to PCM data for each audio object supplied from the audio object decoding unit 212. Thus, the processing for reproducing an audio segment is completed.

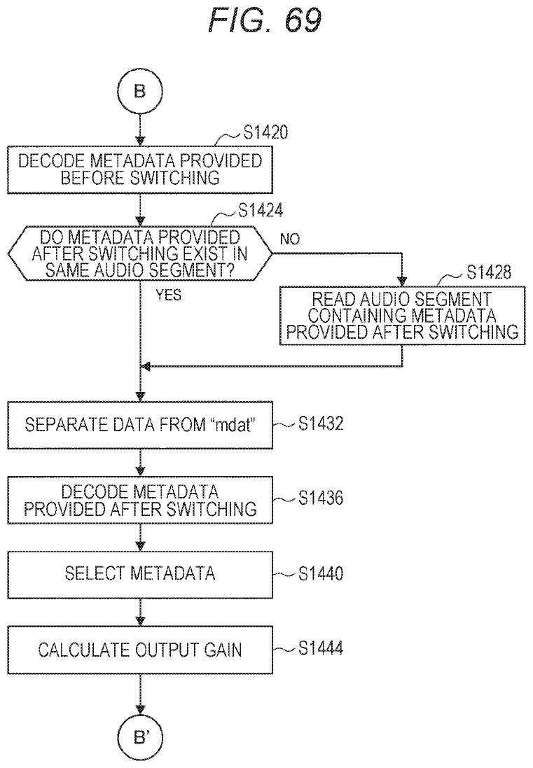

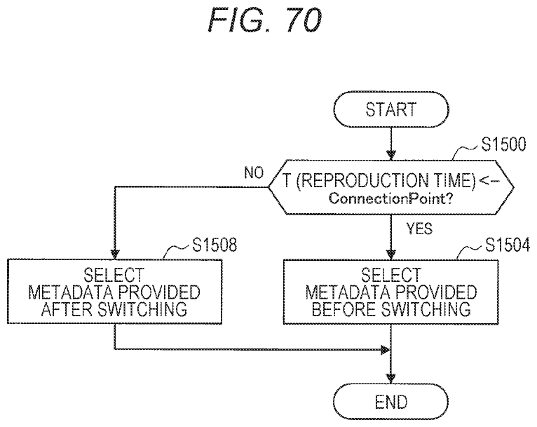

Next, a specific example of the flow of processing for selecting metadata, which is performed in step S1440 of FIG. 69, will be described with reference to FIG. 70.

In step S1500, the metadata selection unit 214 of the client apparatus 200 confirms whether or not time at which reproduction is performed (reproduction time) is at the ConnectionPoint or earlier. In a case where the reproduction time is at the ConnectionPoint or earlier (step S1500/Yes), the metadata selection unit 214 selects, in step S1504, metadata provided before switching as metadata to be used for reproduction processing. Thus, the flow of processing for selecting metadata ends. In a case where the reproduction time is later than the ConnectionPoint (step S1500/No), the metadata selection unit 214 selects, in step S1508, metadata provided after the switching as metadata to be used for reproduction processing. Thus, the flow of processing for selecting metadata ends.

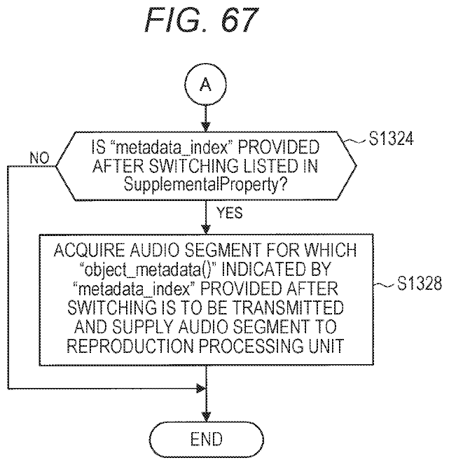

Note that the steps in the flowcharts of FIGS. 63 to 70 described above do not necessarily have to be performed in time series in the described order. That is, the steps in the flowcharts may be performed in an order different from the described order, or may be performed in parallel.

(3.5. Example of Hardware Configuration of Each Apparatus)

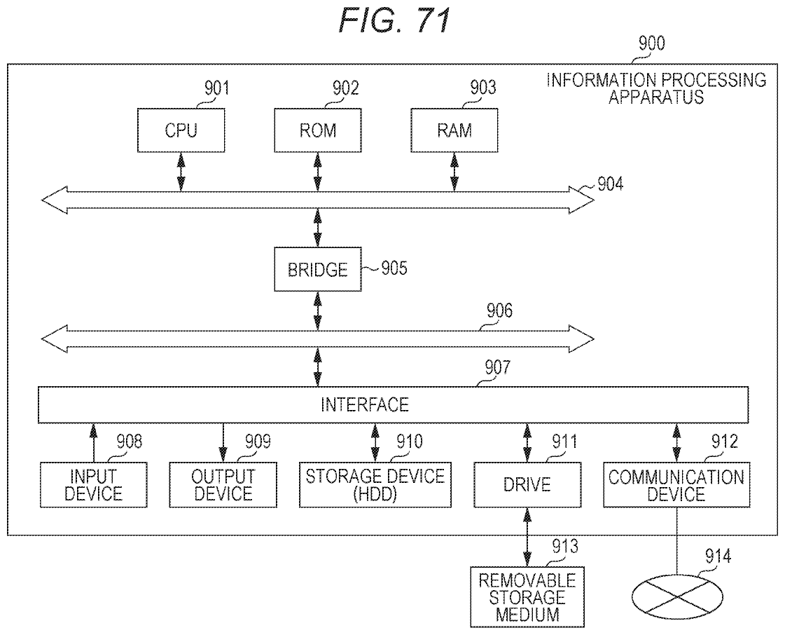

Examples of the processing flow of the client apparatus 200 have been described above. Next, an example of the hardware configuration of the server apparatus 100 or the client apparatus 200 will be described with reference to FIG. 71.

FIG. 71 is a block diagram showing a hardware configuration example of an information processing apparatus 900 that embodies the server apparatus 100 or the client apparatus 200. The information processing apparatus 900 includes a central processing unit (CPU) 901, a read only memory (ROM) 902, a random access memory (RAM) 903, a host bus 904, a bridge 905, an external bus 906, an interface 907, an input device 908, an output device 909, a storage device (HDD) 910, a drive 911, and a communication device 912.

The CPU 901 functions as an arithmetic processing unit and a control device, and controls the overall operation in the information processing apparatus 900 according to various programs. Furthermore, the CPU 901 may be a microprocessor. Programs, operation parameters, and the like to be used by the CPU 901 are stored in the ROM 902. Programs to be used for implementing the CPU 901, and parameters and the like that change as appropriate in the implementation are temporarily stored in the RAM 903. These are connected to each other by the host bus 904 including a CPU bus and the like. Cooperation of the CPU 901, the ROM 902, and the RAM 903 implements the function of the generation unit 110 or the control unit 120 of the server apparatus 100, or the function of the reproduction processing unit 210 or the control unit 220 of the client apparatus 200.

The host bus 904 is connected to the external bus 906 such as a Peripheral Component Interconnect/Interface (PCI) bus via the bridge 905. Note that the host bus 904, the bridge 905, and the external bus 906 do not necessarily have to be configured separately, and these functions may be implemented by a single bus.

The input device 908 includes input means, an input control circuit, and the like. The input means are used by a user to input information. Examples of the input means include a mouse, a keyboard, a touch panel, a button, a microphone, a switch, and a lever. The input control circuit generates an input signal on the basis of a user input, and outputs the input signal to the CPU 901. The user of the information processing apparatus 900 can input various data to each device and instruct each device to perform processing operations, by operating the input device 908.

The output device 909 includes display devices such as a cathode ray tube (CRT) display device, a liquid crystal display (LCD) device, an organic light emitting diode (OLED) device, and a lamp, for example. Moreover, the output device 909 includes audio output devices such as a speaker and headphones. The output device 909 outputs, for example, played content. Specifically, the display devices display, as text or images, various types of information such as reproduced video data. Meanwhile, the audio output devices convert reproduced audio data and the like into sound, and output the sound.

The storage device 910 is a device for storing data. The storage device 910 may include, for example, a storage medium, a recording device that records data in the storage medium, a read-out device that reads data from the storage medium, and a deletion device that deletes the data recorded in the storage medium. The storage device 910 includes, for example, a hard disk drive (HDD). The storage device 910 drives a hard disk to store programs to be executed by the CPU 901 and various data therein. The storage device 910 implements the function of the storage unit 140 of the server apparatus 100, or the function of the storage unit 240 of the client apparatus 200.

The drive 911 is a reader/writer for a storage medium, and is built into or externally attached to the information processing apparatus 900. The drive 911 reads information recorded in a removable storage medium 913 such as a mounted magnetic disk, optical disk, magneto-optical disk, or semiconductor memory, and outputs the read information to the RAM 903. Furthermore, the drive 911 can also write information to the removable storage medium 913.

The communication device 912 is a communication interface including, for example, a device for communication to be used for connecting to a communication network 914. The communication device 912 implements the function of the communication unit 130 of the server apparatus 100 or the function of the communication unit 230 of the client apparatus 200.

### 4. CONCLUSION

As described above, the server apparatus 100 (transmission apparatus) according to the present disclosure generates second stream data that are object data corresponding to first stream data that are bit stream data, and transmits the second stream data to the client apparatus 200 (receiving apparatus). Moreover, the server apparatus 100 includes timing information on the switching of the first stream data in an MPD file or the like to be used for reproducing the second stream data.

As a result, when receiving the second stream data and performing the processing for reproducing the second stream data on the basis of metadata corresponding to the data, the client apparatus 200 can switch the second stream data (strictly speaking, the metadata to be used for reproducing the second stream data) at the timing at which the first stream data are switched, on the basis of the timing information included in the MPD file or the like.

A preferred embodiment of the present disclosure has been described above in detail with reference to the accompanying drawings. However, the technical scope of the present disclosure is not limited to such an example. It will be apparent to those skilled in the art of the present disclosure that various modifications or alterations can be conceived within the scope of the technical idea described in the claims. It is understood that, of course, such modifications or alterations are also within the technical scope of the present disclosure.

Furthermore, the effects described in the present specification are merely explanatory or illustrative, and not restrictive. That is, the technology according to the present disclosure can achieve other effects obvious to those skilled in the art from descriptions in the present specification, together with or instead of the above-described effects.

Note that the following configurations are also within the technical scope of the present disclosure.

(1)

A receiving apparatus including:

a receiving unit that receives second stream data that are object data corresponding to first stream data that are bit stream data.

(2)

The receiving apparatus according to (1) above, further including:

a reproduction processing unit that performs processing for reproducing the second stream data on the basis of metadata corresponding to the second stream data.

(3)

The receiving apparatus according to (2) above, in which

the reproduction processing unit switches the metadata to be used for reproducing the second stream data, according to switching of the first stream data.

(4)

The receiving apparatus according to (3) above, in which

the reproduction processing unit switches the metadata to be used for reproducing the second stream data, at a timing at which the first stream data are switched.

(5)

The receiving apparatus according to (3) or (4) above, in which

the reproduction processing unit switches the metadata to be used for reproducing the second stream data to the metadata corresponding to the first stream data provided after the switching.

(6)

The receiving apparatus according to any one of (1) to (5) above, in which

the first stream data are video stream data, and the second stream data are audio stream data.

(7)

The receiving apparatus according to any one of (1) to (6) above, in which

the second stream data are data defined by MPEG-Dynamic Adaptive Streaming over Http (DASH).

(8)

A receiving method to be performed by a computer, including:

receiving second stream data that are object data corresponding to first stream data that are bit stream data.

(9)

A program for causing a computer to:

receive second stream data that are object data corresponding to first stream data that are bit stream data.

(10)

A transmission apparatus including:

a transmission unit that transmits, to an external device, second stream data that are object data corresponding to first stream data that are bit stream data.

(11)

The transmission apparatus according to (10) above, further including:

a generation unit that generates the second stream data,

in which the generation unit includes information regarding a timing of switching the first stream data in metadata to be used for reproducing the second stream data.

(12)

The transmission apparatus according to (11) above, in which

the generation unit stores at least one piece of metadata to be used for processing for reproducing the second stream data, and object data in the same segment.

(13)

The transmission apparatus according to (11) above, in which

the generation unit stores metadata to be used for processing for reproducing the second stream data, and object data in different segments.

(14)

The transmission apparatus according to any one of (10) to (13) above, in which

the first stream data are video stream data, and the second stream data are audio stream data.

(15)

The transmission apparatus according to any one of (10) to (14) above, in which

the second stream data are data defined by MPEG-Dynamic Adaptive Streaming over Http (DASH).

(16)

A transmission method to be performed by a computer, including:

transmitting, to an external device, second stream data that are object data corresponding to first stream data that are bit stream data.

(17)

A program for causing a computer to:

transmit, to an external device, second stream data that are object data corresponding to first stream data that are bit stream data.

### REFERENCE SIGNS LIST

100 Server apparatus
110 Generation unit
111 Data acquisition unit
112 Encoding processing unit
113 Segment file generation unit
114 MPD file generation unit
120 Control unit
130 Communication unit
140 Storage unit
200 Client apparatus
210 Reproduction processing unit
211 Audio segment analysis unit
212 Audio object decoding unit
213 Metadata decoding unit
214 Metadata selection unit
215 Output gain calculation unit
216 Audio data generation unit
220 Control unit
230 Communication unit
240 Storage unit
300 Internet

1. A receiving apparatus comprising:
a receiving unit that receives second stream data that are object data corresponding to first stream data that are bit stream data.

2. The receiving apparatus according to claim 1, further comprising:
a reproduction processing unit that performs processing for reproducing the second stream data on a basis of metadata corresponding to the second stream data.

3. The receiving apparatus according to claim 2, wherein
the reproduction processing unit switches the metadata to be used for reproducing the second stream data, according to switching of the first stream data.

4. The receiving apparatus according to claim 3, wherein
the reproduction processing unit switches the metadata to be used for reproducing the second stream data, at a timing at which the first stream data are switched.

5. The receiving apparatus according to claim 3, wherein
the reproduction processing unit switches the metadata to be used for reproducing the second stream data to the metadata corresponding to the first stream data provided after the switching.

6. The receiving apparatus according to claim 1, wherein
the first stream data are video stream data, and the second stream data are audio stream data.

7. The receiving apparatus according to claim 1, wherein
the second stream data are data defined by MPEG-Dynamic Adaptive Streaming over Http (DASH).

8. A receiving method to be performed by a computer, comprising:
receiving second stream data that are object data corresponding to first stream data that are bit stream data.

9. A program for causing a computer to:
receive second stream data that are object data corresponding to first stream data that are bit stream data.

10. A transmission apparatus comprising:
a transmission unit that transmits, to an external device, second stream data that are object data corresponding to first stream data that are bit stream data.

11. The transmission apparatus according to claim 10, further comprising:
a generation unit that generates the second stream data,
wherein the generation unit includes information regarding a timing of switching the first stream data in metadata to be used for reproducing the second stream data.

12. The transmission apparatus according to claim 11, wherein
the generation unit stores at least one piece of metadata to be used for processing for reproducing the second stream data, and object data in a same segment.

13. The transmission apparatus according to claim 11, wherein
the generation unit stores metadata to be used for processing for reproducing the second stream data, and object data in different segments.

14. The transmission apparatus according to claim 10, wherein
the first stream data are video stream data, and the second stream data are audio stream data.

15. The transmission apparatus according to claim 10, wherein
the second stream data are data defined by MPEG-Dynamic Adaptive Streaming over Http (DASH).

16. A transmission method to be performed by a computer, comprising:
transmitting, to an external device, second stream data that are object data corresponding to first stream data that are bit stream data.

17. A program for causing a computer to:
transmit, to an external device, second stream data that are object data corresponding to first stream data that are bit stream data.
